(19) United States
(12) Patent Application Publication
(10) Pub. No.: US 2019/0039168 A1
(43) Pub. Date: Feb. 7, 2019

(54) JOINING METHOD

(71) Applicant: NIPPON LIGHT METAL COMPANY, LTD., Tokyo (JP)

(72) Inventors: Hisashi HORI, Shizuoka (JP); Nobushiro SEO, Shizuoka (JP)

(21) Appl. No.: 16/076,301

(22) PCT Filed: Jan. 19, 2017
(86) PCT No.: PCT/JP2017/001823

§ 371 Date: Aug. 7, 2018

(30) Foreign Application Priority Data
Feb. 9, 2016 (JP) 2016-022580
Feb. 24, 2016 (JP) 2016-032840
Mar. 3, 2016 (JP) 2016-040603
Aug. 5, 2016 (JP) 2016-154145
Aug. 5, 2016 (JP) 2016-154179
Sep. 5, 2016 (JP) 2016-172437

(51) Int. Cl. B23K 20/12; B23K 20/26

(52) U.S. Cl. CPC B23K 20/129; B23K 20/125; B23K 2103/04; B23K 20/1265; B23K 20/26

(57) ABSTRACT

A joining method for joining a first metal member with a second metal member with use of a rotary tool having a stirring pin is provided. The joining method includes steps of: butting the first metal member with the second metal member to form a butted portion; arranging an auxiliary member to be in surface-contact with the first metal member or the second metal member; and frictional stirring the butted portion in which the rotating stirring pin is inserted from a front surface of the auxiliary member and the rotary tool is relatively moved in the butted portion to join the first metal member, the second metal member and the auxiliary member, in the state that only the stirring pin is brought in contact with the first metal member, the second metal member and the auxiliary member.

### TECHNICAL FIELD

The present invention relates to a joining method for joining metal members by frictional stirring.

### BACKGROUND ART

For example, Patent Document 1 discloses a joining method for joining a first metal member with a second metal member by frictional stirring. In the joining method, the first metal member is pressed against the second metal member to form a butted portion, and only a stirring pin of a rotary tool is brought in contact with the first metal member and the second metal member to frictionally stir the butted portion.

Further, for example, Patent Document 2 discloses a joining method in which a first metal member is overlaid with a second metal member to form an overlaid portion, and a rotary tool is inserted from a front surface of the second metal member to carry out frictional stir joining. In the frictional stir joining, only a stirring pin is brought in contact with the second metal member during frictional stirring.

For example, Patent Document 3 discloses a joining method in which end surfaces of metal members having varying heights are pressed against each other to form a butted portion having a varying height, and only a stirring pin of a rotary tool is brought in contact with the butted portion of the metal members to carry out frictional stir joining.

### PRIOR ART DOCUMENTS

### Patent Document

Patent Document 1: Japanese Patent Application Publication No. 2013-39613

Patent Document 2: Japanese Patent Application Publication No. 2015-139800

Patent Document 3: Japanese Patent Application Publication No. 2015-199119

### SUMMARY OF THE INVENTION

### Problems to be Solved by the Invention

In the joining method according to Patent Document 1, since a shoulder portion of the rotary tool fails to restrain a plastically fluidized metal from flowing, the plastically fluidized metal flows outside so that a joined portion is short of metal. Further, when long metal members are pressed against each other, the butted portion may have a gap so that the joined portion is short of metal.

In the joining method according to Patent Document 2, since a shoulder portion of the rotary tool fails to restrain a plastically fluidized metal from flowing, the plastically fluidized metal flows outside so that a joined portion is short of metal and a recessed grooved is formed on the front surface of the second metal member.

In the joining method according to Patent Document 3, since a shoulder portion of the rotary tool fails to restrain a plastically fluidized metal from flowing, the plastically fluidized metal flows outside so that a joined portion is short of metal and a recessed groove is formed on the front surface of the butted portion.

The present invention provides a joining method that prevents metal shortage in a joined portion.

### Means to Solve the Problems

To solve the problems described above, the present invention provides a joining method for joining a first metal member with a second metal member with use of a rotary tool having a stirring pin, including steps of: butting the first metal member with the second metal member to form a butted portion; arranging an auxiliary member to be in surface-contact with the first metal member or the second metal member; and frictional stirring the butted portion in which the rotating stirring pin is inserted from a front surface of the auxiliary member and the rotary tool is relatively moved in the butted portion to join the first metal member, the second metal member and the auxiliary member, in the state that only the stirring pin is brought in contact with the first metal member, the second metal member and the auxiliary member.

Further, the present invention provides a joining method for joining a first metal member with a second metal member with use of a rotary tool having a stirring pin, including steps of: butting the first metal member with the second metal member to form a butted portion; arranging an auxiliary member to be in surface-contact with the first metal member and the second metal member; and frictional stirring the butted portion in which the rotating stirring pin is inserted from a front surface of the auxiliary member and the rotary tool is relatively moved in the butted portion to join the first metal member, the second metal member and the auxiliary member, in the state that only the stirring pin is brought in contact with the first metal member, the second metal member and the auxiliary member.

According to the joining method, when the first metal member is joined with the second metal member, the auxiliary member is also joined by frictional stirring, to prevent metal shortage in the joined portion.

Further, a removing step is preferably included in which the auxiliary member having a burr is removed from the first metal member or the second metal member. According to the joining method, the burr is removed with the whole auxiliary member to facilitate the removing step.

Further, in the frictional stirring step, a joining condition is preferably set such that the burr to be generated in frictional stir joining is generated on the auxiliary member. According to this joining method, the burr is easily removed.

Further, preferably, in the arranging step, the auxiliary member is arranged on one of the first metal member and the second metal member so as to slightly run over (protrude) the butted portion onto the other such that the auxiliary member is not left on the other after the frictional stirring step, and, in the frictional stirring step, a joining condition is set such that the burr to be generated in frictional stir joining is generated on the auxiliary member on said one of the first metal member and the second metal member.

According to this joining method, the burr is easily removed. Further, since the auxiliary member is slightly run over the butted portion toward the other, metal shortage in the joined portion is prevented more reliably.

Further, the present invention provides a joining method for joining a first metal member with a second metal member with use of a rotary tool having a stirring pin, including steps of: butting the first metal member with the second metal member to form a butted portion; arranging an auxiliary member to be in surface-contact with the first metal member or the second metal member; and frictional stirring the butted portion in which the rotating stirring pin is inserted from a front surface of the auxiliary member and the rotary tool is relatively moved in the butted portion to join the first metal member, the second metal member and the auxiliary member, in the state that only the stirring pin is brought in contact with the first metal member, the second metal member and the auxiliary member, wherein, in the butting step, a gap is defined in the butted portion when the butted portion is formed.

Further, the present invention provides a joining method for joining a first metal member with a second metal member with use of a rotary tool having a stirring pin, including steps of: butting the first metal member with the second metal member to form a butted portion; arranging an auxiliary member to be in surface-contact with the first metal member and the second metal member; and frictional stirring the butted portion in which the rotating stirring pin is inserted from a front surface of the auxiliary member and the rotary tool is relatively moved in the butted portion to join the first metal member, the second metal member and the auxiliary member, in the state that only the stirring pin is brought in contact with the first metal member, the second metal member and the auxiliary member, wherein, in the butting step, a gap is defined in the butted portion when the butted portion is formed.

According to this joining method, when the first metal member is joined with the second metal member, the auxiliary member is also joined by frictional stirring to prevent metal shortage in the joined portion. Further, in the butting step, even when the gap is defined in the butted portion when the butted portion is formed, the plastically fluidized metal fills the gap.

Further, to solve the problems described above, the present invention provides a joining method for joining a first metal member with a second metal member with use of a rotary tool having a stirring pin, including steps of: preparing the first metal member and the second metal member that is thinner than the first metal member; butting an end surface of the first metal member with an end surface of the second metal member to form a butted portion and a first uneven level; arranging an auxiliary member on the first uneven level; and frictional stirring the butted portion in which the rotating stirring pin is inserted from front surfaces of the first metal member and the second metal member into the first uneven level and the rotary tool is relatively moved in the butted portion for frictional stir joining, in the state that only the stirring pin is brought in contact with the first metal member, the second metal member and the auxiliary member.

Further, the present invention provides a joining method for joining a first metal member with a second metal member with use of a rotary tool having a stirring pin, including steps of: butting an end surface of the first metal member with an end surface of the second metal member to form a butted portion and a first uneven level; arranging an auxiliary member on the first uneven level; and frictional stirring the butted portion in which the rotating stirring pin is inserted from front surfaces of the first metal member and the second metal member into the first uneven level and the rotary tool is relatively moved in the butted portion for frictional stir joining, in the state that only the stirring pin is brought in contact with the first metal member, the second metal member and the auxiliary member.

According to this joining method, when the first metal member is joined with the second metal member, the auxiliary member is also joined by frictional stirring to prevent metal shortage in the joined portion.

Further, a removing step is preferably included in which the auxiliary member having a burr is removed from the first metal member and the second metal member. According to this joining method, the burr is removed with the whole auxiliary member to facilitate the removing step.

Further, in the frictional stirring step, a joining condition is preferably set such that the burr to be generated in frictional stir joining is generated on the auxiliary member. According to this joining method, the burr is easily removed.

Further, in the arranging step, the auxiliary member is preferably arranged such that the front surface of the first metal member is flush with that of the auxiliary member. According to this joining method, the rotary tool is easily inserted.

Further, in the arranging step, the auxiliary member is preferably arranged such that the front surface of the auxiliary member is positioned higher than that of the first metal member. According to this joining method, metal shortage in the joined portion is reliably prevented.

Further, in the arranging step, the auxiliary member is preferably arranged such that the front surface of the auxiliary member is positioned lower than the front surface of the first metal member. According to the joining method, the auxiliary member is easily removed.

Further, in the frictional stirring step, frictional stir joining is preferably executed in the butted portion in the state that the rotation axis of the rotary tool is shifted toward the auxiliary member with respect to the butted portion. Further, in the frictional stirring step, frictional stir joining is preferably executed in the butted portion in the state that the rotation axis of the rotary tool is inclined toward the auxiliary member.

According to this joining method, since the auxiliary member is frictionally stirred more, metal shortage in the joined portion is reliably prevented.

Further, to solve the problems described above, the present invention provides a joining method for joining a first metal member with a second metal member with use of a rotary tool having a stirring pin, including steps of: overlaying a rear surface of the second metal member on a front surface of the first metal member to form an overlaid portion; arranging an auxiliary member to be in surface-contact with a front surface of the second metal member; and frictional stirring the overlaid portion in which the rotating stirring pin is inserted from a front surface of the auxiliary member and the rotary tool is relatively moved to join the first metal member, the second metal member and the auxiliary member, in the state that only the stirring pin is brought in contact with the second metal member and the auxiliary member or is brought in contact with the first metal member, the second metal member and the auxiliary member.

According to this joining method, when the overlaid portion is joined, the auxiliary member is also joined by frictional stirring besides the first metal member and the second metal member to prevent metal shortage in the joined portion. This prevents a recessed groove from being formed in the front surface of the second metal member.

Further, a removing step is preferably included in which the auxiliary member having a burr is removed from the second metal member. According to this joining method, the burr is removed with the whole auxiliary member.

Further, in the frictional stirring step, the stirring pin is preferably inserted in a center of the auxiliary member. According to this joining method, metal shortage is prevented more reliably. Further, the rotary tool is easily inserted in the auxiliary member.

Further, in a case where a reference line is set to run across an end surface of the auxiliary member and to be orthogonal to the first metal member and the second metal member, preferably, in the frictional stirring step, the stirring pin is relatively moved so that the rotation axis of the rotary tool is in line with the reference line, and a joining condition is set such that the burr is generated on the auxiliary member.

According to this joining method, the auxiliary member is left on only one side of the rotary tool to facilitate the removing step.

Further, in a case where a reference line is set to run across an end surface of the auxiliary member and to be orthogonal to the first metal member and the second metal member, preferably, in the frictional stirring step, when the rotary tool is relatively moved, the rotation axis of the rotary tool is slightly shifted toward a center of the auxiliary member with respect to the reference line so that the auxiliary member is left only on one side of the rotary tool after the frictional stirring step, and a joining condition is set such that the burr is generated on the left auxiliary member.

According to this joining method, the auxiliary member is left only on one side of the rotary tool to facilitate the removing step. Further, since the rotation axis of the rotary tool is slightly shifted toward the center of the auxiliary member with respect to the reference line, metal shortage in the joined portion is prevented more reliably. Still further, the rotary tool is easily inserted in the auxiliary member.

Further, to solve the problems described above, the present invention provides a joining method for joining a first metal member with a second metal member with use of a rotary tool having a stirring pin, including steps of: overlaying a rear surface of the second metal member, at least whose rear surface has a varying height on a front surface of the first metal member, at least whose front surface has a varying height, to form an overlaid portion having a varying height; arranging an auxiliary member to be in surface-contact with a front surface of the second metal member; and frictional stirring the overlaid portion in which the rotating stirring pin is inserted from a front surface of the auxiliary member and the rotary tool is relatively moved to join the first metal member, the second metal member and the auxiliary member, in the state that only the stirring pin of the rotary tool is brought in contact with the second metal member and the auxiliary member or is brought in contact with the first metal member, the second metal member and the auxiliary member.

According to this method, when the overlaid portion having a varying height is joined, the auxiliary member is joined by frictional stirring besides the first and second metal members, each having a varying height, to prevent metal shortage in the joined portion. This prevents a recessed groove from being formed in the front surface of the second metal member.

Further, a removing step is included, in which the auxiliary member having a burr is removed from the second metal member.

According to this method, the burr is removed with the whole auxiliary member.

Further, in the frictional stirring step, the stirring pin is inserted in a center of the auxiliary member.

According to this method, metal shortage is prevented more reliably. Further, the rotary tool is easily inserted in the auxiliary member.

Further, in a case where a reference line is set to run across an end surface of the auxiliary member and to be orthogonal to the first metal member and the second metal member, in the frictional stirring step, the stirring pin is relatively moved so that the rotation axis of the rotary tool is in line with the reference line, and a joining condition is set such that the burr is generated on the auxiliary member.

According to this method, the auxiliary member is left on only one side of the rotary tool to facilitate the removing step.

Further, in a case where a reference line is set to run across an end surface of the auxiliary member and to be orthogonal to the first metal member and the second metal member, in the frictional stirring step, when the rotary tool is relatively moved, the rotation axis of the rotary tool is slightly shifted toward a center of the auxiliary member with respect to the reference line so that the auxiliary member is left only on one side of the rotary tool after the frictional stirring step, and a joining condition is set such that the burr is generated on the remaining auxiliary member.

According to this method, the auxiliary member is left only on one side of the rotary tool to facilitate the removing step. Further, since the rotation axis of the rotary tool is slightly shifted toward the center of the auxiliary member with respect to the reference line, metal shortage in the joined portion is prevented more reliably. Still further, the rotary tool is easily inserted in the auxiliary member.

Further, to solve the problems described above, the present invention provides a joining method for joining a first metal member with a second metal member with use of a rotary tool having a stirring pin, including steps of: butting the first metal member having a front surface a height of which varies with the second metal member having a front surface a height of which varies to form a butted portion; arranging an auxiliary member to be in surface-contact with the first metal member or the second metal member; and frictional stirring the butted portion in which the rotating stirring pin is inserted from a front surface of the auxiliary member into the butted portion a height of which varies, and the rotary tool is relatively moved in the butted portion to join the first metal member, the second metal member and the auxiliary member, in the state that only the stirring pin of the rotary tool is brought in contact with the first metal member, the second metal member and the auxiliary member.

According to this method, when the butted portion having a varying height is joined, the auxiliary member is also joined by frictional stirring besides the first and second metal members, each having a varying height, to prevent metal shortage in the joined portion. This prevents a recessed groove from being formed in the front surfaces of the first metal member and the second metal member.

Further, a removing step is included, in which the auxiliary member having a burr is removed from the first metal member or the second metal member.

According to this method, the burr is removed with the whole auxiliary member.

Further, in the frictional stirring step, a joining condition is set such that the burr to be generated in frictional stir joining is generated on the auxiliary member.

According to this method, all burrs are removed with the whole auxiliary member.

Further, the present invention provides a joining method for joining a first metal member with a second metal member with use of a rotary tool having a stirring pin, including steps of: butting the first metal member having a front surface a height of which varies with the second metal member having a front surface a height of which varies to form a butted portion; arranging an auxiliary member to be in surface-contact with the first metal member and the second metal member; and frictional stirring the butted portion in which the rotating stirring pin is inserted from a front surface of the auxiliary member into the butted portion having a varying height, and the rotary tool is relatively moved in the butted portion to join the first metal member, the second metal member and the auxiliary member, in the state that only the stirring pin of the rotary tool is brought in contact with the first metal member, the second metal member and the auxiliary member.

According to this method, when the butted portion having a varying height is joined, the auxiliary member is also joined by frictional stirring besides the first and second metal members, each having a varying height, to prevent metal shortage in the joined portion. This prevents a recessed groove from being formed in the front surfaces of the first metal member and the second metal member. Further, since the stirring pin is inserted into the butted portion at around the center of the auxiliary member, the stirring pin is easily inserted in the auxiliary member.

Further, a removing step is included, in which the auxiliary member having a burr is removed from the first metal member and the second metal member.

According to this method, though the burrs are generated on respective parts of the auxiliary member that are divided in the frictional stirring step, the burrs are removed with the whole auxiliary member.

Further, in the arranging step, the auxiliary member is arranged on one of the first metal member and the second metal member to slightly run over (protrude) the butted portion onto the other, and, in the frictional stirring step, a joining condition is set such that the burr to be generated in frictional stir joining is generated on the auxiliary member on said one of the first metal member and the second metal member.

According to this method, since the slightly protruded portion of the auxiliary member is frictionally stirred to fill the joined portion, metal shortage in the joined portion is prevented more reliably in a well-balanced manner. Further, since the rotation axis to be inserted in the butted portion is positioned slightly toward the center from the end surface of the auxiliary member, the stirring pin is easily inserted in the auxiliary member.

Further, a spiral groove is formed on a peripheral surface of the stirring pin, and, when the rotary tool is rotated clockwise, the spiral groove is formed counterclockwise from a base end to a distal end of the stirring pin, and, when the rotary tool is rotated counterclockwise, the spiral groove is formed clockwise from the base end to the distal end of the stirring pin.

According to this method, since the plastically fluidized metal material is lead through the spiral groove to move toward the distal end of the stirring pin, the amount of metal overflowing out of the metal members is reduced.

### Advantageous Effects of the Invention

The joining method according to the present invention can prevent metal shortage in a joined portion.

### BRIEF DESCRIPTION OF THE DRAWINGS

FIG. 1 is a cross-sectional view showing a butting step and an arranging step in a first embodiment of the present invention;

FIG. 2 is a cross-sectional view showing a frictional stirring step according to the first embodiment;

FIG. 3 is a cross-sectional view after the frictional stirring step according to the first embodiment;

FIG. 4 is a cross-sectional view showing a removing step according to the first embodiment;

FIG. 5 is a cross-sectional view after the removing step according to the first embodiment;

FIG. 6 is a cross-sectional view showing the butting step and the arranging step according to a second embodiment;

FIG. 7 is a cross-sectional view showing the frictional stirring step according to the second embodiment;

FIG. 8 is a cross-sectional showing the removing step according to the second embodiment;

FIG. 9 is a cross-sectional view showing the butting step and the arranging step according to a third embodiment;

FIG. 10 is a cross-sectional view showing the frictional stirring step according to the third embodiment;

FIG. 11 is a cross-sectional view showing the removing step according to the third embodiment;

FIG. 12 is a cross-sectional view showing a preparing step, the butting step and the arranging step according to a fourth embodiment of the present invention;

FIG. 13 is a cross-sectional view showing the frictional stirring step according to the fourth embodiment;

FIG. 14 is a cross-sectional view after the frictional stirring step according to the fourth embodiment;

FIG. 15 is a cross-sectional view of the removing step according to the fourth embodiment;

FIG. 16 is a cross-sectional view showing the arranging step according to a first modification of the fourth embodiment;

FIG. 17 is a cross-sectional view showing the arranging step according to a second modification of the fourth embodiment;

FIG. 18 is a cross-sectional view showing the frictional stirring step according to a third modification of the fourth embodiment;

FIG. 19 is a cross-sectional view showing the frictional stirring step according to a fifth embodiment;

FIG. 20 is a cross-sectional view after the frictional stirring step according to the fifth embodiment;

FIG. 21 is a cross-sectional view showing an overlaying step and the arranging step according to a sixth embodiment of the present invention;

FIG. 22 is a cross-sectional view showing the frictional stirring step according to the sixth embodiment;

FIG. 23 is a cross-sectional view after the frictional stirring step according to the sixth embodiment;

FIG. 24 is a cross-sectional view showing the removing step according to the sixth embodiment;

FIG. 25 is a cross-sectional view after the removing step according to the sixth embodiment;

FIG. 26 is a cross-sectional view showing the overlaying step and the arranging step according to a seventh embodiment;

FIG. 27 is a cross-sectional view showing the frictional stirring step according to the seventh embodiment;

FIG. 28 is a cross-sectional view showing the removing step according to the seventh embodiment;

FIG. 29 is a cross-sectional view showing the overlaying step and the arranging step of an eighth embodiment;

FIG. 30 is a cross-sectional view showing the frictional stirring step according to the eighth embodiment;

FIG. 31 is a cross-sectional view showing the removing step according to the eighth embodiment;

FIG. 32 is a perspective view of a first metal member, a second metal member and an auxiliary member used in the joining method according to a ninth embodiment of the present invention;

FIG. 33 is a cross-sectional view showing the overlaying step and the arranging step in the joining method according to the ninth embodiment;

FIG. 34 is a perspective view showing the frictional stirring step in the joining method according to the ninth embodiment;

FIG. 35 is a cross-sectional view showing the frictional stirring step in the joining method according to the ninth embodiment;

FIG. 36 is a cross-sectional view showing the frictional stirring step in the joining method according to the ninth embodiment;

FIG. 37 is a cross-sectional view showing the joining method according to the ninth embodiment before the removing step;

FIG. 38 is a cross-sectional view showing the removing step in the joining method according to the ninth embodiment;

FIG. 39 is a cross-sectional view of the joining method according to the ninth embodiment after the removing step;

FIG. 40 is a cross-sectional view showing the frictional stirring step (modification) in the joining method according to the ninth embodiment;

FIG. 41 is a cross-sectional view showing the overlaying step and the arranging step according to a tenth embodiment of the present invention;

FIG. 42 is a perspective view showing the frictional stirring step in the joining method according to the tenth embodiment;

FIG. 43 is a cross-sectional view showing the frictional stirring step in the joining method according to the tenth embodiment;

FIG. 44 is a cross-sectional view of the removing step in the joining method according to the tenth embodiment;

FIG. 45 is a cross-sectional view showing the overlaying step and the arranging step according to an eleventh embodiment of the present invention;

FIG. 46 is a perspective view showing the frictional stirring step in the joining method according to the eleventh embodiment;

FIG. 47 is a cross-sectional view showing the frictional stirring step in the joining method according to the eleventh embodiment;

FIG. 48 is a cross-sectional view showing the removing step in the joining method according to the eleventh embodiment;

FIG. 49 is a cross-sectional view showing the frictional stirring step in the joining method according to another embodiment;

FIG. 50 is a perspective view of the first metal member and the second metal member used in the joining method according to a twelfth embodiment of the present invention;

FIG. 51 is a perspective view showing the butting step in the joining method according to the twelfth embodiment;

FIG. 52 is a perspective view of the first metal member, the second metal member and the auxiliary member used in the joining method according to the twelfth embodiment;

FIG. 53 is a side cross-sectional view showing the butting step and the arranging step in the joining method according to the twelfth embodiment;

FIG. 54 is a perspective view showing the frictional stirring step in the joining method according to the twelfth embodiment;

FIG. 55 is a cross-sectional view showing the frictional stirring step in the joining method according to the twelfth embodiment;

FIG. 56 is a cross-sectional view showing the frictional stirring step in the joining method according to the twelfth embodiment;

FIG. 57 is a cross-sectional view showing the joining method according to the twelfth embodiment before the removing step;

FIG. 58 is a cross-sectional view showing the removing step in the joining method according to the twelfth embodiment;

FIG. 59 is a cross-sectional view showing the joining method according to the twelfth embodiment after the removing step;

FIG. 60 is a cross-sectional view showing the frictional stirring step (modification) in the joining method according to the twelfth embodiment;

FIG. 61 is a cross-sectional view showing the butting step and the arranging step according to the thirteenth embodiment of the present invention;

FIG. 62 is a perspective view showing the frictional stirring step in the joining method according to the thirteenth embodiment;

FIG. 63 is a cross-sectional view showing the frictional stirring step in the joining method according to the thirteenth embodiment;

FIG. 64 is a cross-sectional view showing the removing step in the joining method according to the thirteenth embodiment;

FIG. 65 is a cross-sectional view showing the butting step and the arranging step according to a fourteenth embodiment of the present invention;

FIG. 66 is a perspective view showing the frictional stirring step in the joining method according to the fourteenth embodiment;

FIG. 67 is a cross-sectional view showing the frictional stirring step in the joining method according to the fourteenth embodiment;

FIG. 68 is a cross-sectional view showing the removing step in the joining method according to the fourteenth embodiment;

FIG. 69 is a cross-sectional view showing the butting step in the joining method according to another embodiment; and

FIG. 70 is a side cross-sectional view showing the frictional stirring step in the joining method according to another embodiment.

### EMBODIMENTS OF THE INVENTION

### First Embodiment

A description will be given in detail of a joining method according to a first embodiment of the present invention, with reference to the accompanying drawings. The joining method according to the present embodiment includes a butting step, an arranging step, a frictional stirring step and a removing step. Note that a “front surface” in the following description indicates an opposite surface of a “rear surface”.

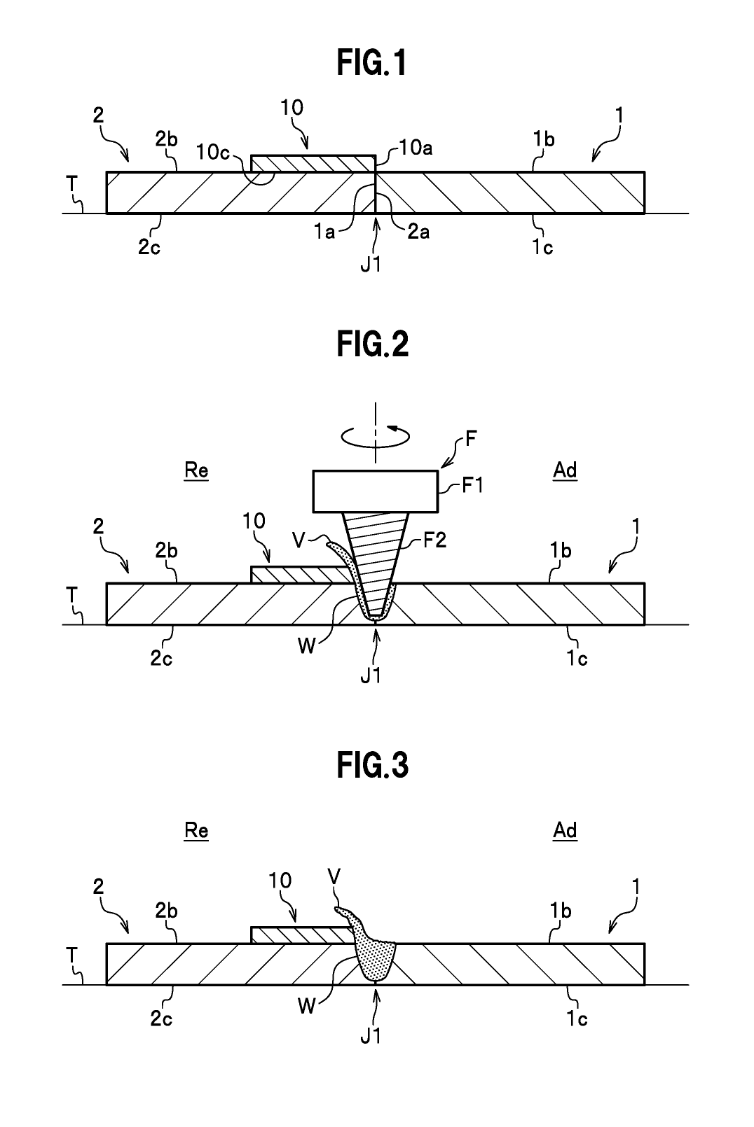

As shown in FIG. 1, in the butting step, a first metal member 1 is pressed (butted) against a second metal member 2. The first metal member 1 and the second metal member 2 are metal plate members. The material of the first metal member 1 and the second metal member 2 is not particularly limited as long as it is a frictional stirrable metal, and may be appropriately selected from, for example, an aluminum, an aluminum alloy, a copper, a copper alloy, a titanium, a titanium alloy, a magnesium, a magnesium alloy, etc. The first metal member 1 and the second metal member 2 are formed to have the same thickness. The thicknesses of the first metal member 1 and the second metal member 2 may be set appropriately.

In the butting step, an end surface la of the first metal member 1 is pressed against an end surface 2a of the second metal member 2 to form a butted portion J1. When the butted portion J1 is formed, a gap may be defined between the end surface 1a of the first metal member 1 and the end surface 2a of the second metal member 2. The gap is about 1 mm. A front surface 1b of the first metal member 1 is flush with a front surface 2b of the second metal member 2.

In the arranging step, an auxiliary member 10 is arranged on the first metal member 1 or the second metal member 2. The auxiliary member 10 is a metal plate member. The auxiliary member 10 is not particularly limited as long as it is a frictional stirrable metal. In the present embodiment, the auxiliary member 10 is made of the same material as the first metal member 1 and the second metal member 2. The thickness of the auxiliary member 10 is appropriately set to prevent metal shortage in a plasticized region W after a frictional stirring step to be described later. In the present embodiment, the thickness of the auxiliary member 10 is set to be thinner than the first metal member 1.

In the arranging step, a rear surface 10c of the auxiliary member 10 is brought in contact with the front surface 2b of the metal member 2. The auxiliary member 10 is arranged to surface-contact with only the second metal member 2 (or the first metal member 1). In the present embodiment, the end surface 10a of the auxiliary member 10 is arranged to be flush with the end surface 2a of the second metal member 2. Further, the first metal member 1, the second metal member 2 and the auxiliary member 10 are immovably fixed to a frame T with a jig (not shown). Note that the auxiliary member 10 in the present embodiment is in a plate shape, but may have another shape.

As shown in FIG. 2, in the frictional stirring step, the butted portion J1 between the first metal member 1 and the second metal member 2 is joined by frictional stirring with a joining rotary tool F. The joining rotary tool F has a coupling portion F1 and a stirring pin F2. The joining rotary tool F corresponds to a “rotary tool” in the appended claims. The joining rotary tool F is formed, for example, of tool steel. The coupling portion F1 is coupled to a rotation shaft (not shown) of a frictional stir device. The coupling portion F1 is in a cylindrical shape.

The stirring pin F2 extends downward from the coupling portion F1 and is coaxial therewith. The stirring pin F2 tapers off with the increasing distance from the coupling portion F1. A spiral groove is formed on the outer circumferential surface of the stirring pin F2. In the present embodiment, since the joining rotary tool F is rotated counterclockwise, the spiral groove is formed clockwise from the base end toward the distal end. In other words, the spiral groove can be traced from the base end toward the distal end to find that it is formed clockwise as viewed from above.

Note that, in a case where the joining rotary tool F is rotated clockwise, the spiral groove is preferably formed counterclockwise from the base end toward the distal end. In other words, the spiral groove in this case can be traced from the base end to the distal end to find that it is formed counterclockwise as viewed from above. The spiral groove formed in this way allows a plastically fluidized metal to be led toward the distal end of the stirring pin F2 via the spiral groove during frictional stirring. This reduces the amount of metal overflowed out of the joined metal members (first metal member 1, second metal member 2 and auxiliary member 10). The spiral groove may be omitted.

The joining rotary tool F may be attached to the frictional stir device such as a machining center, or may be attached to an arm robot having, for example, a rotary device such as a spindle unit at the distal end. The joining rotary tool F attached to the arm robot allows an inclination angle of the rotation axis of the joining rotary tool F to be easily changed.

In the frictional stirring step, only the stirring pin F2 rotated counterclockwise is inserted in the butted portion J1 to relatively move while coupling portion F1 is kept away from the joined metal members. In other words, the base end of the stirring pin F2 is being exposed during frictional stir joining. Then, the joining rotary tool F is relatively moved in the butted portion J1 in the state that the stirring pin F2 is in contact with the first metal member 1, the second metal member 2 and the auxiliary member 10. In the present embodiment, the joining rotary tool F is set to travel such that the auxiliary member 10 positions at the left in the traveling direction of the joining rotary tool F. The rotating direction and the traveling direction of the joining rotary tool F is not limited to those described above and may be set appropriately. For example, the joining rotary tool F may be rotated clockwise while the auxiliary member 10 is arranged at the left in the traveling direction of the joining rotary tool F. Further, the joining rotary tool F may be rotated in either direction while the auxiliary member 10 is arranged at the right in the traveling direction of the joining rotary tool F. A condition such as the rotating direction of the joining rotary tool F and a preferable positional relationship with the auxiliary member 10 will be described later.

An insertion depth of the stirring pin F2 may be set appropriately according to the thicknesses of the first metal member 1 and the second metal member 2 and the like, while the stirring pin F2 is in contact with the butted portion J1. Accordingly, the butted portion J1 is joined by frictional stirring. The plasticized region W is generated on the track where the joining rotary tool F has been moved. As shown in FIG. 3, after the frictional stirring step, burrs V are generated on the end portion of the auxiliary member 10.

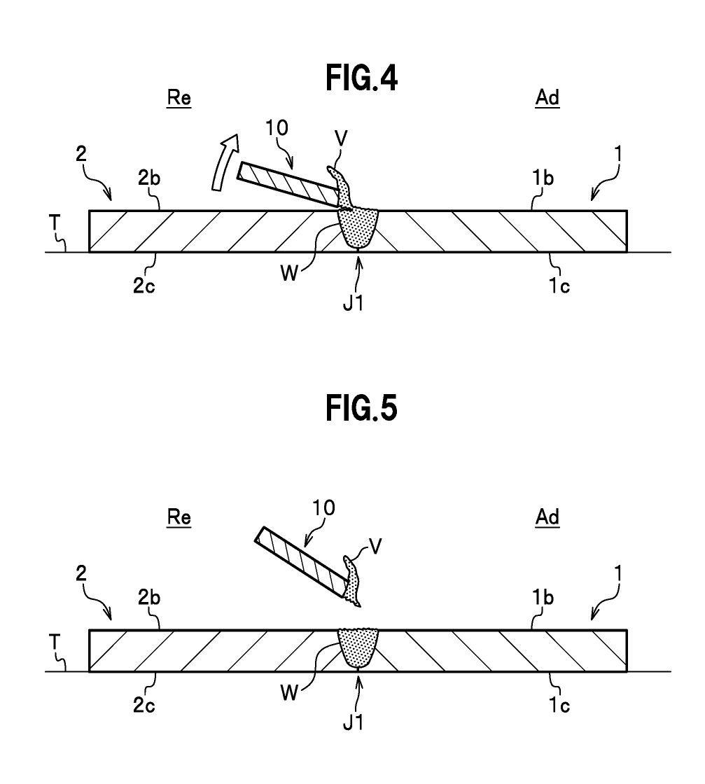

As shown in FIG. 4, in the removing step, the auxiliary member 10 is removed from the second metal member 2. In the removing step, the auxiliary member 10 is folded toward a direction away from the second metal member 2 manually, for example, manually to be removed from the second metal member 2. Thus, as shown in FIG. 5, the first metal member 1 is flatly joined with the second metal member 2 flatly.

According to the joining method of the present embodiment described above, when the first metal member 1 is joined with the second metal member 2, the auxiliary member 10 is also joined by frictional stirring. This prevents metal shortage in the joined portion (plasticized region W). Further, the auxiliary member 10 is joined by frictional stirring together with the first metal member 1 and the second metal member 2. Even if a gap is defined in the butted portion J1, the plastically fluidized metal fills the gap to prevent metal shortage in the joined portion (plasticized region W). Still further, according to the present embodiment, the auxiliary member 10 arranged on only one of the first metal member 1 and the second metal member 2 (not both on the metal members 1, 2) prevents metal shortage.

Further, according to the present embodiment, the burrs V are generated on the auxiliary member 10 in the frictional stirring step, but are removed together with the whole auxiliary member 10 in the removing step. Thus, the burrs are easily removed. As shown in FIG. 3, after the frictional stirring step, the end surface of the auxiliary member 10 becomes thinner toward the butted portion J1. The auxiliary member 10 may be removed with the removing device or the like, but is removed easily manually in the present embodiment.

Here, in the joining method according to the present embodiment, the auxiliary member 10 is set to be thinner than the first metal member 1 and the second metal member 2. If the shoulder portion is pressed against the metal members for frictional stirring, as with a conventional method, the shoulder portion is brought in contact with the auxiliary member 10, to cause the auxiliary member 10 to be scattered outside, so that metal shortage in the joined portion is not compensated. In contrast, in the present embodiment, since only the stirring pin F2 of the joining rotary tool F is brought in contact with the first metal member 1, the second metal member 2 and the auxiliary member 10 for frictional stirring, the auxiliary member 10 is not scattered outside, so that the metal shortage in the joined portion is compensated. Further, a load applied to the frictional stir device is reduced as compared with the case where the shoulder portion is contacted.

Further, as shown in FIG. 2, in the frictional stirring step according to the present embodiment, the auxiliary member 10 is arranged at the left in the traveling direction and the joining rotary tool F is rotated counterclockwise, to set the auxiliary member 10 as being on a retreating side (Re side). The retreating side is a side (also referred to as a “flow side”) on which a feeding speed is subtracted from a tangential speed on the circumference of the joining rotary tool F. By contrast, the opposite side of the retreating side is referred to as an advancing side (Ad side). The advancing side is a side (also referred to as a “shear side”) on which the feeding speed is added to the tangential speed on the circumference of the joining rotary tool F.

In a case where the rotating speed of the joining rotary tool F is slow, for example, the temperature of the plastically fluidized material in the plasticized region W increases on the Ad side more than on the Re side, to cause the burrs V to be generated more on the Ad side. In contrast, in a case where the rotating speed of the joining rotary tool F is fast, for example, though the temperature of the plastically fluidized material rises more on the Ad side, the high rotating speed causes the burrs V to be generated more on the Re side.

In the present embodiment, since the rotating speed of the joining rotary tool F is set to be fast, the burrs V are generated on the Re side, that is, on the auxiliary member 10. In other words, in the present invention, the rotating speed, the rotating direction, the traveling direction and the like of the joining rotary tool F are set such that the burrs V are generated more on the auxiliary member 10. Accordingly, the burrs V generated on the auxiliary member 10 are removed together with the whole auxiliary member 10, to facilitate a burr removing step. Further, setting the rotating speed of the joining rotary tool F to be fast allows the moving speed (feeding speed) of the joining rotary tool F to be increased. This shortens a joining cycle.

As described above, in the frictional stirring step, it depends on a joining condition on which side of the traveling direction of the joining rotary tool F the burrs V are generated. The joining condition is determined by each factor such as the rotating speed, the rotation direction, the moving direction and the moving speed (feeding speed) of the joining rotary tool F, the inclination angle (tapered angle) of the stirring pin F2, the materials of the first metal member 1, the second metal member 2 and the auxiliary member 10, and the thickness of each member, and combinations thereof. Depending on the joining condition, the auxiliary member 10 is preferably arranged on the side on which the burrs V are generated or are generated more, to facilitate the burr removing step.

### Second Embodiment

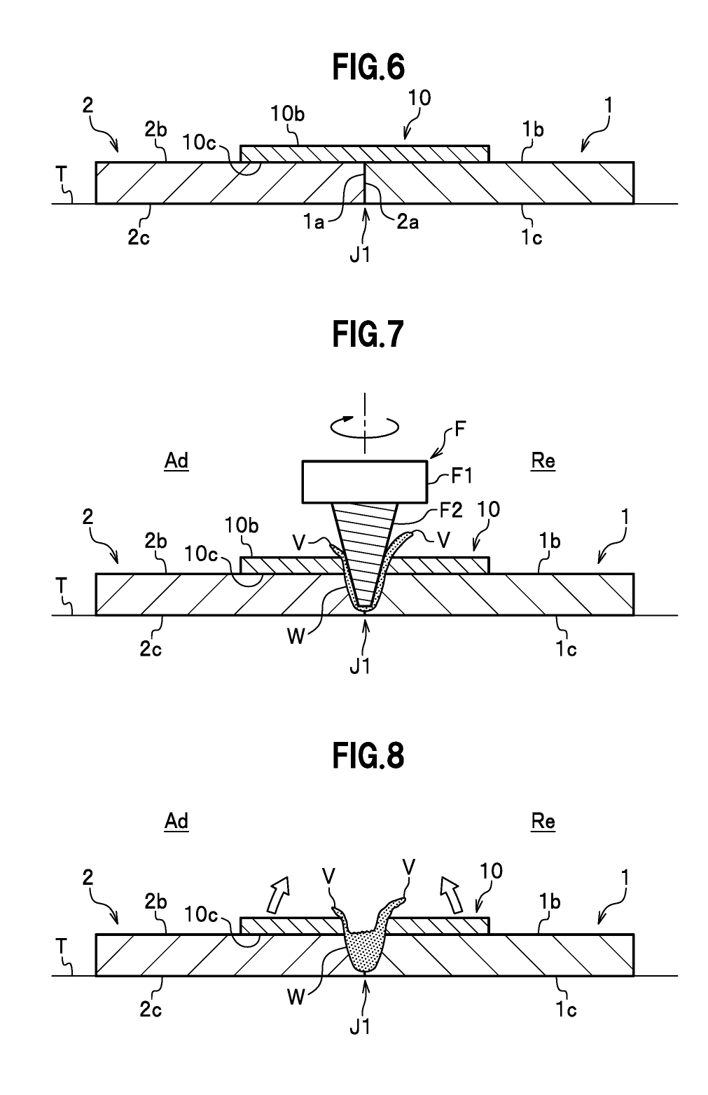

Next, a description will be given of the joining method according to a second embodiment. As shown in FIG. 6, the joining method according to the second embodiment differs from the first embodiment in that the auxiliary member 10 is arranged to be in contact with both the first metal member 1 and the second metal member 2. The joining method according to the second embodiment will be described, focusing on the difference from the first embodiment.

The joining method according to the present embodiment includes the butting step, the arranging step, the frictional stirring step and the removing step. The butting step is the same as that in the first embodiment and the description thereof will be omitted. In the arranging step, the auxiliary member 10 is arranged on both the first metal member 1 and the second metal member 2.

As shown in FIG. 6, in the arranging step, the front surface 1b of the first metal member 1 and the front surface 2b of the second metal member 2 are brought in contact with the rear surface 10c of the auxiliary member 10. The thickness of the auxiliary member 10 is appropriately set to prevent metal shortage in the plasticized region W after the frictional stirring step to be described later. In the arranging step, the center of the auxiliary member 10 is arranged to be approximately positioned at the butted portion J1. Further, the first metal member 1, the second metal member 2 and the auxiliary member 10 are immovably fixed by the jig (not shown).

As shown in FIG. 7, in the frictional stirring step, the butted portion J1 between the first metal member 1 and the second metal member 2 is joined by frictional stirring with the joining rotary tool F. In the present embodiment, since the joining rotary tool F is rotated clockwise, the spiral groove of the stirring pin F2 is formed counterclockwise from the base end toward the distal end. In the frictional stirring step, the stirring pin F2 rotated clockwise is inserted from a front surface 10b of the auxiliary member 10, to set an insertion depth of the stirring pin F2 so as to reach the butted portion J1. In the frictional stirring step, only the stirring pin F2 rotated clockwise is inserted in the butted portion J1 and then moved, while the coupling portion F1 is kept away from the joined metal members. In other words, the base end of the stirring pin F2 is kept exposed during frictional stir joining. In the state that the stirring pin F2 is in contact with the first metal member 1, the second metal member 2 and the auxiliary member 10, the joining rotary tool F is relatively moved in the butted portion J1 from the near side toward the far side in FIG. 7. Accordingly, the butted portion J1 is joined by frictional stirring. The plasticized region W is formed on the trace on which the joining rotary tool F has been moved. Note that, in the present embodiment, since the joining rotary tool F is rotated at a high speed, the burrs tend to be generated more on the Re side than the Ad side.

As shown in FIG. 8, in the removing step, the auxiliary member 10 divided in the frictional stirring step is removed from the first metal member 1 and the second metal member 2. In the removing step, each auxiliary member 10 is folded toward a direction away from the first metal member 1 and the second metal member 2, and then removed.

According to the joining method of the present embodiment described above, when the first metal member 1 is joined with the second metal member 2 flatly, and the auxiliary member 10 is also joined by frictional stirring, to prevent metal shortage in the joined portion (plasticized region W). Further, since the auxiliary member 10 is joined by frictional stirring together with the first metal member 1 and the second metal member 2, even if a gap is defined in the butted portion J1, the plastically fluidized metal fills the gap and prevents metal shortage in the joined portion (plasticized region W). Still further, since the auxiliary member 10 is arranged to straddle on both the first metal member 1 and the second metal member 2, the metal shortage in the joined portion is more reliably prevented and the metal is replenished in a well-balanced manner.

Further, according to the present embodiment, the burrs V, V are generated on each auxiliary member 10, 10 divided in the frictional stirring step, but are removed together with the whole auxiliary member 10 in the removing step. Thus, the burrs are easily removed. The auxiliary member 10 may be removed with the removing device, but is easily removed manually in the present embodiment.

### Third Embodiment

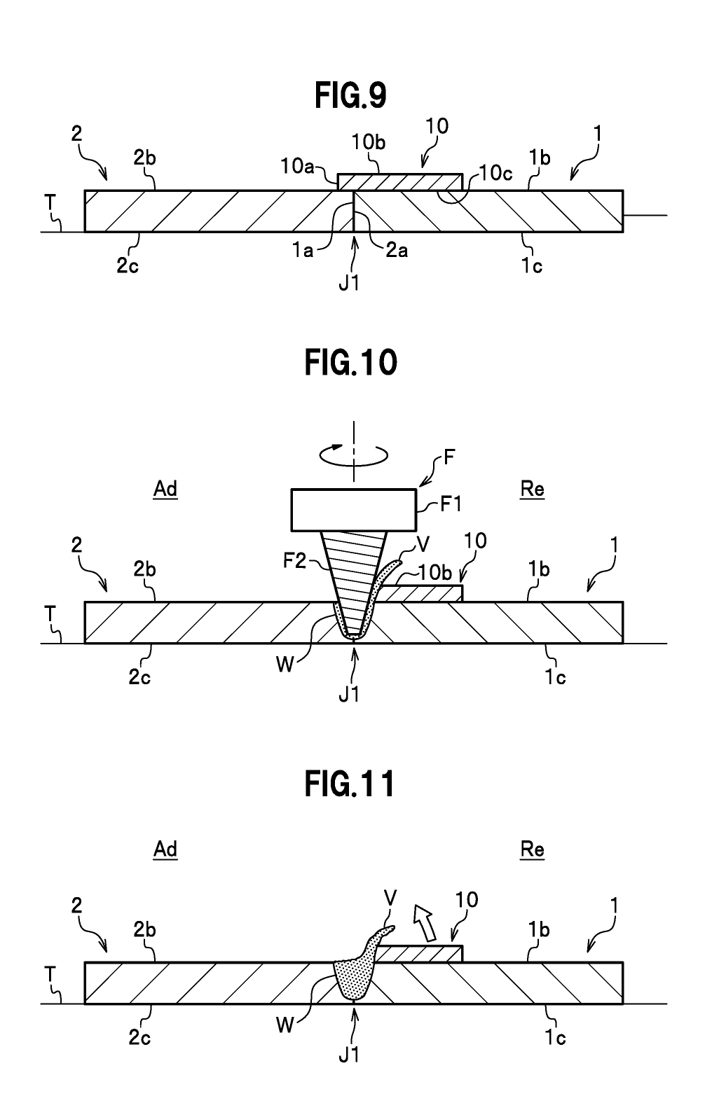

Next, a description will be given of the joining method according to a third embodiment of the present invention. As shown in FIG. 9, the joining method according to the third embodiment differs from the first embodiment in that, in the arranging step, the auxiliary member 10 is arranged on both the first metal member 1 and the second metal member 2, but a contact ratio of the first metal member 1 and the second metal member 2 to the auxiliary member 10 is changed. Further, the rotating direction of the joining rotary tool F also differs from that in the first embodiment. The joining method according to the third embodiment will be described, focusing on the differences from the first embodiment. The joining method according to the third embodiment includes the butting step, the arranging step, the frictional stirring step and the removing step.

The butting step is the same as that in the first embodiment and the description thereof will be omitted. As shown in FIG. 9, in the arranging step, the front surface 1b of the first metal member 1 and the front surface 2b of the second metal member 2 are brought in contact with the rear surface 10c of the auxiliary member 10. In the arranging step, approximately 90% of the auxiliary member 10 is arranged on the first metal member 1, and the remaining approximately 10% is arranged on the second metal member 2. In other words, the auxiliary member 10 is arranged to slightly run over (protrude) onto the second metal member 2 with respect to the butted portion J1. The auxiliary member 10 is arranged to be in surface-contact with both the first metal member 1 and the second metal member 2, and is arranged so as not to be left on the second metal member 2 (one contacting less with the auxiliary member 10) after the frictional stirring step to be described later.

As shown in FIG. 10, in the frictional stirring step, the butted portion J1 between the first metal member 1 and the second metal member 2 is joined by frictional stirring with the joining rotary tool F. In the present embodiment, since the joining rotary tool F is rotated clockwise, the spiral groove of the stirring pin F2 is formed counterclockwise from the base end toward the distal end.

In the frictional stirring step, only the stirring pin F2 rotated clockwise is inserted in the butting portion J1 to be relatively moved while the coupling portion F1 is kept away from the joined metal members. In other words, the base end of the stirring pin F2 is being exposed during frictional stir joining. Then, the joining rotary tool F is relatively moved in the butted portion J1 in the state that the stirring pin F2 is in contact with the first metal member 1, the second metal member 2 and the auxiliary member 10. In the present embodiment, the joining rotary tool F is set to travel such that the auxiliary member 10 positions at the right in the traveling direction of the joining rotary tool F. Accordingly, since the first metal member 1 is on the Re side in the present embodiment, the burrs V are generated more on the auxiliary member 10.

As shown in FIG. 11, in the removing step, the auxiliary member 10 is removed from the first metal member 1. In the removing step, the auxiliary member 10 is folded toward a direction away from the first metal member 1 manually, for example, to be removed from the first metal member 1.

According to the joining method of the present embodiment described above, the first metal member 1 is flatly joined with the second metal member 2, and the auxiliary member 10 is also joined by frictional stirring besides the first metal member 1 and the second metal member 2, to prevent metal shortage in the joined portion (plasticized region W). Further, since the auxiliary member 10 is joined by frictional stirring together with the first metal member 1 and the second metal member 2, even if a gap is defined in the butted portion J1, the plastically fluidized metal fills the gap and prevents the metal shortage in the joined portion (plasticized region W).

Further, according to the joining condition of the present embodiment, since the rotating speed of the joining rotary tool F is set to be fast, the burrs V are generated more on the Re side. In other words, in the present embodiment, the rotating direction and the traveling direction of the joining rotary tool F and the like (joining condition) are set such that the burrs V are generated more on a part of the auxiliary member 10 on the first metal 1. Accordingly, the burrs V generated on the auxiliary member 10 are removed together with the whole auxiliary member 10, to facilitate the burr removing step. Further, as shown in FIG. 11, after the frictional stirring step, the end surface of the auxiliary member 10 becomes thinner toward the butted portion J1. The auxiliary member 10 may be removed with the removing device or the like, but is easily removed manually in the present embodiment.

Here, in the removing step in the second embodiment described above, auxiliary members 10, 10 on both sides of the butted portion J1 need to be removed. However, in the present embodiment, the auxiliary member 10 is arranged so as not to be left on the second metal member 2 (one having less contact with the auxiliary member 10) after the frictional stirring step. Therefore, only the auxiliary member 10 on one side needs to be removed in the removing step. Accordingly, a work in the removing step is reduced. Further, in the arranging step, the auxiliary member 10 slightly runs over (protrudes) toward the second metal member 2 (other side) across the butted portion J1, to prevent metal shortage in the joined portion more reliably in a well-balanced manner.

The embodiment of the present invention has been described above, but may be changed appropriately within the scope not departing from the spirit of the present invention. For example, the removing step is included in the embodiment, but the auxiliary member 10 may not be removed to remain as is on the first metal member 1 or the second metal member 2.

### Fourth Embodiment

A description will be given in detail of the joining method according to a fourth embodiment of the present invention with reference to the drawings. The joining method according to the present embodiment includes a preparing step, the butting step, the arranging step, the frictional stirring step and the removing step.

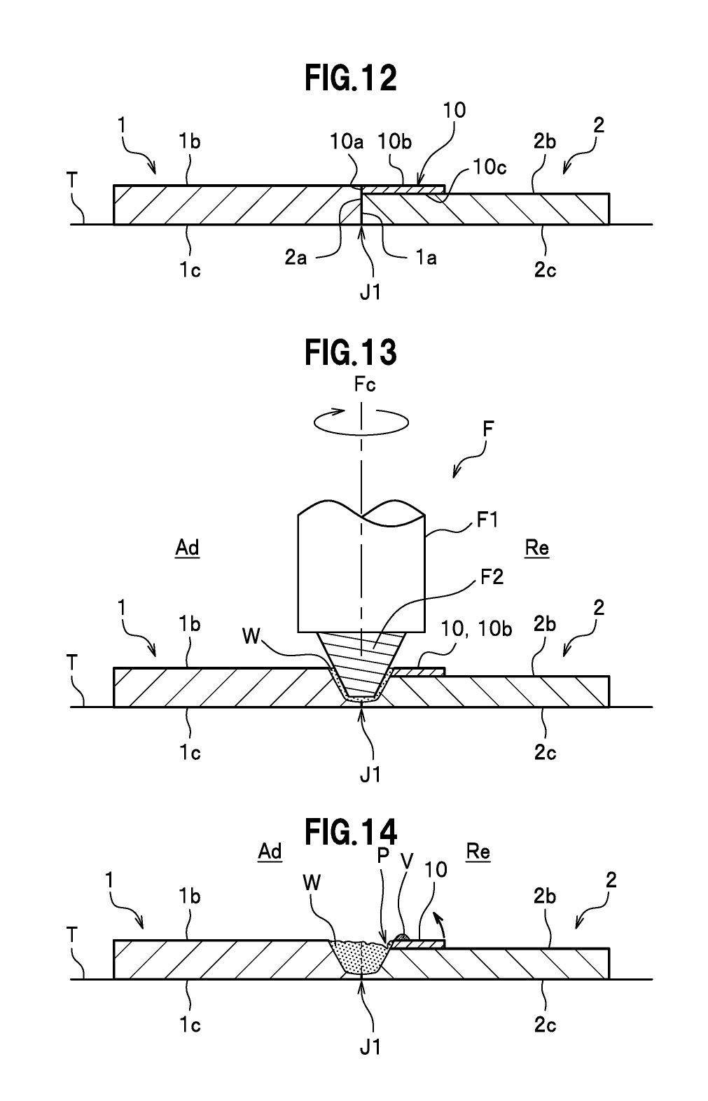

As shown in FIG. 12, in the preparing step, the first metal member 1 and the second metal member 2 are prepared. The first metal member 1 and the second metal member 2 are in a plate shape. The first metal member 1 is thicker than the second metal member 2. The material of the first metal member 1 and the second metal member 2 is not particularly limited as long as it is a frictional stirrable metal, and may be appropriately selected from, for example, an aluminum, an aluminum alloy, a copper, a copper alloy, a titanium, a titanium alloy, a magnesium, a magnesium alloy, etc.

As shown in FIG. 12, in the butting step, the first metal member 1 is pressed against the second metal member 2. In the butting step, the end surface la of the first metal member 1 is pressed against the end surface 2a of the second metal member 2 to form the butted portion J1. Further, a first uneven level is defined by the front surface 1b, the end surface la of the first metal member 1 and the front surface 2b of the second metal member 2.

As shown in FIG. 12, in the arranging step, the auxiliary member 10 is arranged on the first uneven level. The auxiliary member 10 is a metal plate member. The auxiliary member 10 is not particularly limited as long as it is a frictional stirrable metal. In the present embodiment, the auxiliary member 10 is made of the same material as the first metal member 1 and the second metal member 2. The thickness of the auxiliary member 10 is equal to the height of the first uneven level (height from the front surface 2b to the front surface 1b). Accordingly, the front surface 1b of the first metal member 1 is flush with the front surface 10b of the auxiliary member 10. Note that the height of the first uneven level (thickness of the auxiliary member 10) is appropriately set to prevent metal shortage in the plasticized region W after the frictional stirring step to be described later.

In the arranging step, the rear surface 10c of the auxiliary member 10 is brought in contact with the front surface 2b of the second metal member 2, and the end surface 10a of the auxiliary member 10 is brought in contact with the end surface 1a of the first metal member 1. Further, the first metal member 1, the second metal member 2 and the auxiliary member 10 are immovably fixed to the frame T with the jig (not shown).

As shown in FIG. 13, in the frictional stirring step, the butted portion J1 between the first metal member 1 and the second metal member 2 is joined by frictional stirring with the joining rotary tool F. The joining rotary tool F has the coupling portion F1 and the stirring pin F2.

In the present embodiment, since the joining rotary tool F is rotated clockwise, the spiral groove is formed counterclockwise from the base end toward the distal end. In other words, the spiral groove can be traced from the base end toward the distal end to find that it is formed counterclockwise as viewed from above.

The spiral groove formed in this way allows a plastically fluidized metal to be led toward the distal end of the stirring pin F2 via the spiral groove during frictional stirring. This reduces the amount of metal overflowed out of the joined metal members (first metal member 1, second metal member 2 and auxiliary member 10). The spiral groove may be omitted.

The joining rotary tool F may be attached to a frictional stir device such as a machining center, or may be attached to an arm robot, for example, having a rotary device such as a spindle unit at the distal end. The joining rotary tool F attached to the arm robot allows an inclination angle of the rotation axis Fc of the joining rotary tool F to be easily changed.

In the frictional stirring step, only the stirring pin F2 rotated clockwise is inserted in the butted portion J1 and then relatively moved, while the connection portion F1 is kept away from the joined metal members. In other words, the base end of the stirring pin F2 is kept exposed during frictional stir joining. In the state that the stirring pin F2 is in contact with the first metal member 1, the second metal member 2 and the auxiliary member 10, the joining rotary tool F is relatively moved in the butted portion J1 from the near side toward the far side in FIG. 13.

In the present embodiment, the joining rotary tool F is set to travel such that the auxiliary member 10 is positioned at the right in the traveling direction of the joining rotary tool F. The rotating direction and the traveling direction of the joining rotary tool F is not limited to those as described above and may be set appropriately. For example, the joining rotary tool F may be rotated counterclockwise while the auxiliary member 10 is arranged at the right in the traveling direction of the joining rotary tool F. Alternatively, the joining rotary tool F may be rotated in either direction while the first uneven level is defined and the auxiliary member 10 is arranged at the left in the traveling direction of the joining rotary tool F. A condition such as a rotating direction of the joining rotary tool F and a preferable positional relationship with the auxiliary member 10 will be described later.

An insertion depth of the stirring pin F2 may be set appropriately according to the thicknesses of the first metal member 1 and the second metal member 2 and the like, while the stirring pin F2 is in contact with the butted portion J1. Accordingly, the butted portion J1 is joined by frictional stirring. The plasticized region W is generated on the track where the joining rotary tool F passed through. As shown in FIG. 14, after the frictional stirring step, a recessed groove P is formed in the auxiliary member 10 and the burrs V are generated on the end portion of the auxiliary member 10.

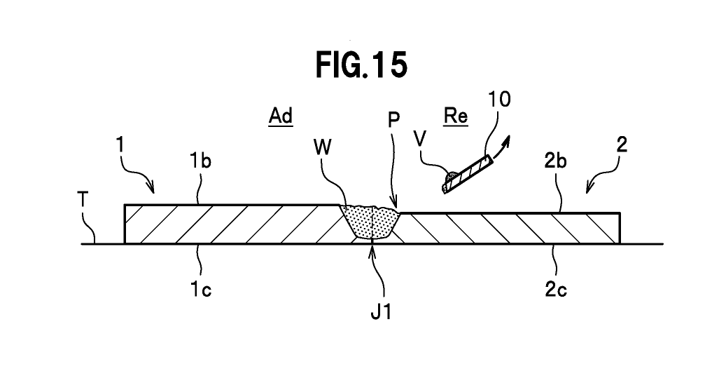

As shown in FIG. 14, in the removing step, the auxiliary member 10 is removed from the second metal member 2. In the removing step, as shown in FIG. 15, the auxiliary member 10 is folded toward a direction away from the second metal member 2 with respect to the recessed groove P mutually, for example, to be removed from the second metal member 2.

According to the joining method of the present embodiment described above, when the first metal member 1 is joined with the second metal member 2, the auxiliary member 10 is also joined by frictional stirring. This prevents metal shortage in the joined portion (plasticized region W).

Further, according to the present embodiment, the burrs V are generated on the auxiliary member 10 in the frictional stirring step, but are removed together with the whole auxiliary member 10 in the removing step. Thus, the burrs are easily removed. The auxiliary member 10 may be removed with the removing device or the like, but is removed easily manually in the present embodiment. Still further, according to the present embodiment, even if the first metal member 1 has a different thickness from that of the second metal member 2, since the auxiliary member 10 is used, metal shortage in the joined portion is prevented.

Yet further, in the present embodiment, since the front surface 10b of the auxiliary member 10 is flush with the front surface 1b of the first metal member 1, the joining rotary tool F is easily inserted during the frictional stirring step.

Here, in the joining method according to the present embodiment, the auxiliary member 10 is set to be thinner than the first metal member 1 and the second metal member 2. If the shoulder portion is pressed against the metal members for frictional stirring as in a conventional method, the shoulder portion is brought in contact with the auxiliary member 10, to cause the auxiliary member 10 to be scattered outside, so that metal shortage in the joined portion is not compensated. On the other hand, in the present embodiment, since only the stirring pin F2 of the joining rotary tool F is brought in contact with the first metal member 1, the second metal member 2 and the auxiliary member 10 for frictional stirring, the auxiliary member 10 is not scattered outside, so that the metal shortage in the joined portion is compensated. In addition, a load applied to the frictional stir device is reduced as compared with the case where the shoulder portion is contacted.

Further, as shown in FIG. 13, in the frictional stirring step according to the present embodiment, since the auxiliary member 10 is arranged at the right in the traveling direction and the joining rotary tool F is rotated clockwise, the auxiliary member 10 is set to be on the Re side.

In the present embodiment, since the rotating speed of the joining rotary tool F is set to be fast, the burrs V are generated on the Re side, that is, the auxiliary member 10. In other words, in the present embodiment, the joining condition is set such that the burrs V are generated more on the auxiliary member 10. Accordingly, the burrs V generated on the auxiliary member 10 are removed together with the whole auxiliary member 10, to facilitate the burr removing step. Further, setting the rotating speed of the joining rotary tool F to be fast allows the moving speed (feeding speed) of the joining rotary tool F to be increased. This shortens a joining cycle.

As described above, in the frictional stirring step, it depends on the joining condition on which side of the traveling direction of the joining rotary tool F the burrs V are generated. The auxiliary member 10 is preferably arranged on the side on which the burrs V are generated or are generated more according to the joining condition, to easily execute the burr removing step.

### [First Modification]

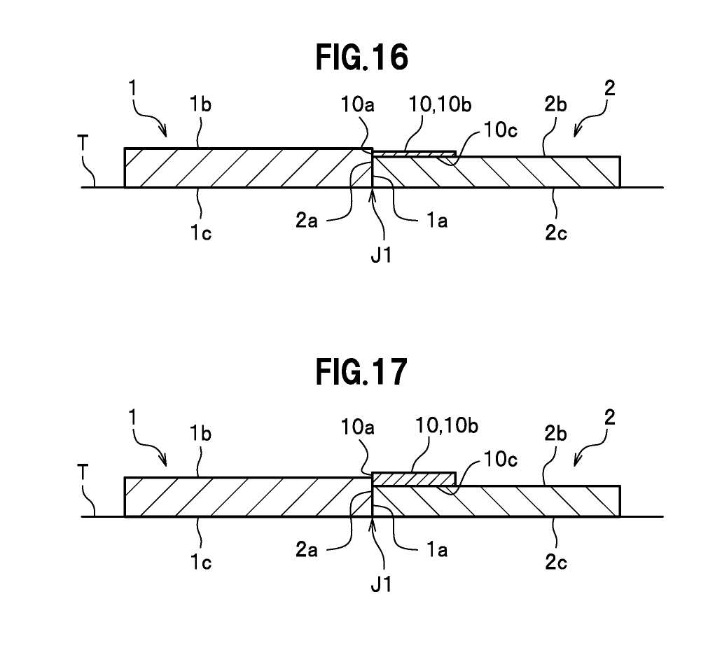

Next, a description will be given of a first modification of the fourth embodiment. As shown in FIG. 16, in the arranging step of the first modification differs from the fourth embodiment in that an uneven level is defined by the first metal member 1 and the auxiliary member 10. In other words, since the thickness of the auxiliary member 10 is thinner than the height of the first uneven level, the front surface 10b of the auxiliary member 10 is positioned lower than the front surface 1b of the first metal member 1. Accordingly, a second uneven level is defined by the front surface 1b and end surface 1a of the first metal member 1 and the front surface 10b of the auxiliary member 10. Other steps are the same as those in the fourth embodiment and the descriptions thereof will be omitted.

According to the first modification, since the auxiliary member 10 is set to be thinner than the height of the first uneven level, the auxiliary member 10 is easily taken off. This allows the auxiliary member 10 to be easily removed in the removing step.

### [Second Modification]

Next, a description will be given of a second modification of the fourth embodiment. As shown in FIG. 17, the arranging step of the second modification differs from the fourth embodiment in that an uneven level is defined by the first metal member 1 and the auxiliary member 10. In other words, since the auxiliary member 10 is set to be thicker than the height of the first uneven level, the front surface 10b of the auxiliary member 10 is positioned higher than the front surface 1b of the first metal member 1. Thus, a second uneven level is defined by the front surface 1b of the first metal member 1, and the end surface 10a and front surface 10b of the auxiliary member 10. Other steps are the same as those in the fourth embodiment and the descriptions thereof will be omitted.

According to the second modification, the auxiliary member 10 is set to be thicker than the height of the first uneven level. Accordingly, in the frictional stirring step, since the auxiliary member 10 is frictionally stirred more than the case in the fourth embodiment, metal shortage is prevented more reliably.

### [Third Modification]

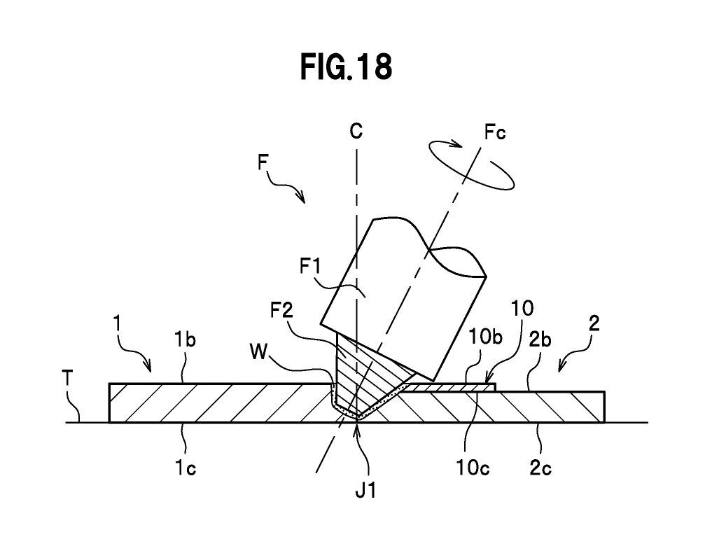

Next, a description will be given of a third modification of the fourth embodiment. As shown in FIG. 18, in the frictional stirring step of the third modification, the joining rotary tool F having the rotation axis Fc is relatively moved in the butted portion J1, in the state of being inclined toward the auxiliary member 10 with respect to a boundary C running through the butted portion J1, to join the butted portion J1 by frictional stirring. Thus, since the joining rotary tool F is inclined toward the auxiliary member 10, the auxiliary member 10 is frictionally stirred more than the case in the fourth embodiment, to prevent the metal shortage more reliably.

### Fifth Embodiment

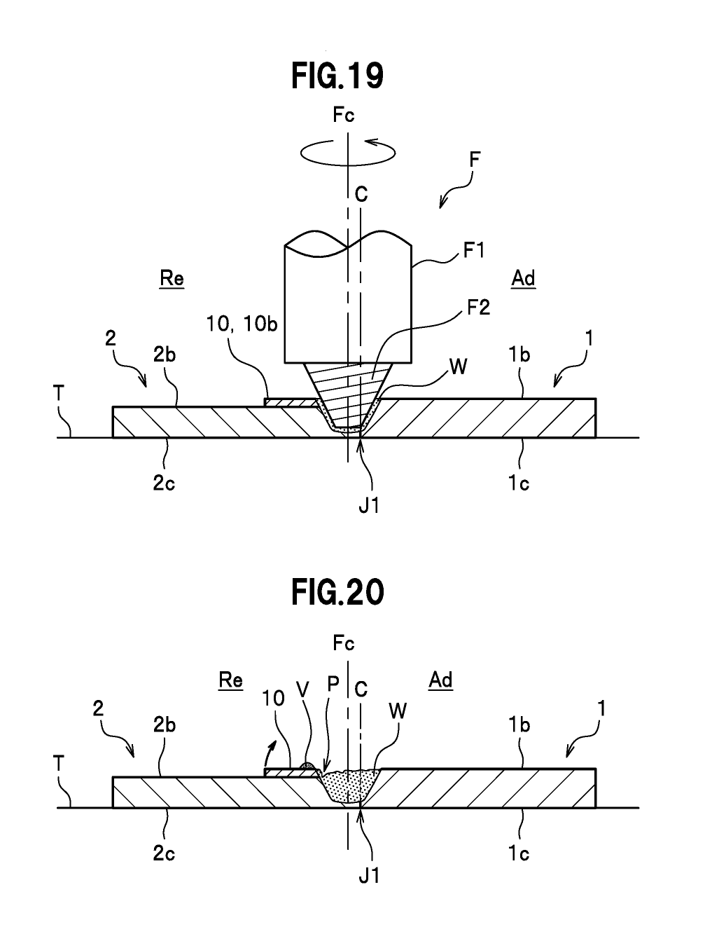

Next, a description will be given of the joining method according to a fifth embodiment. As shown in FIG. 19, the joining method according to the fifth embodiment is mainly different in that the rotation axis Fc of the joining rotary tool F is shifted toward the center of the auxiliary member with respect to the butted portion J1. The joining method according to the present embodiment includes the preparing step, the butting step, the arranging step, the frictional stirring step and the removing step. The preparing step, the butting step and the arranging step are substantially the same as those in the fourth embodiment and the descriptions thereof will be omitted.

As shown in FIGS. 19 and 20, in the frictional stirring step according to the fifth embodiment, the butted portion J1 is joined by frictional stirring with the joining rotary tool F. In the frictional stirring step according to the present embodiment, the auxiliary member 10 is arranged at the left in the traveling direction of the joining rotary tool F and the joining rotary tool F is rotated counterclockwise. Accordingly, the right side is set to be the Ad side and the left side is set to be the Re side in the traveling direction. Further, in the frictional stirring step according to the present embodiment, the rotation axis Fc of the joining rotary tool F is shifted toward the center of the auxiliary member with respect to the butted portion J1 (boundary C), and the shifted joining rotary tool F is relatively moved to be in parallel with the butted portion J1.

In the removing step, the auxiliary member 10 is folded in the same manner as in the fourth embodiment with respect to the recessed groove P to remove the burrs V together with the whole auxiliary member 10.

In the frictional stirring step according to the fifth embodiment described above, since the rotation axis Fc of joining rotation tool F is shifted for frictional stirring, the auxiliary member 10 is frictionally stirred more than the case in the fourth embodiment. Accordingly, metal shortage in the joined portion (plasticized region W) is reliably prevented. Further, in the present embodiment, since the joining rotary tool F is rotated at a high speed, the burrs V are generated on the Re side, that is, on the auxiliary member 10. In the frictional stirring step according to the present embodiment, the joining condition is set such that the burrs V are generated on the auxiliary member 10, and the burrs V are removed together with the auxiliary member 10, to easily remove the burrs V.

Some embodiments and modifications of the present invention have been described above, but may be modified appropriately within the scope not departing from the spirit of the present invention. For example, in the present embodiments, the first metal member 1 has a thickness different from that of the second metal member 2, but may have the same thickness. In the butting step in this case, the first metal member 1 and the second metal member 2 having the same thicknesses may be butted by shifting the end surfaces with each other to define an uneven to form the butted portion J1.

Further, in the first to third modifications, the joining rotary tool F may be shifted from the butted portion J1 (boundary C) as described in the fifth embodiment for frictional stir joining.

### Sixth Embodiment

A description will be given in detail of the joining method according to a sixth embodiment of the present invention with reference to the drawings. The joining method according to the present embodiment includes an overlaying step, the arranging step, the frictional stirring step and the removing step.

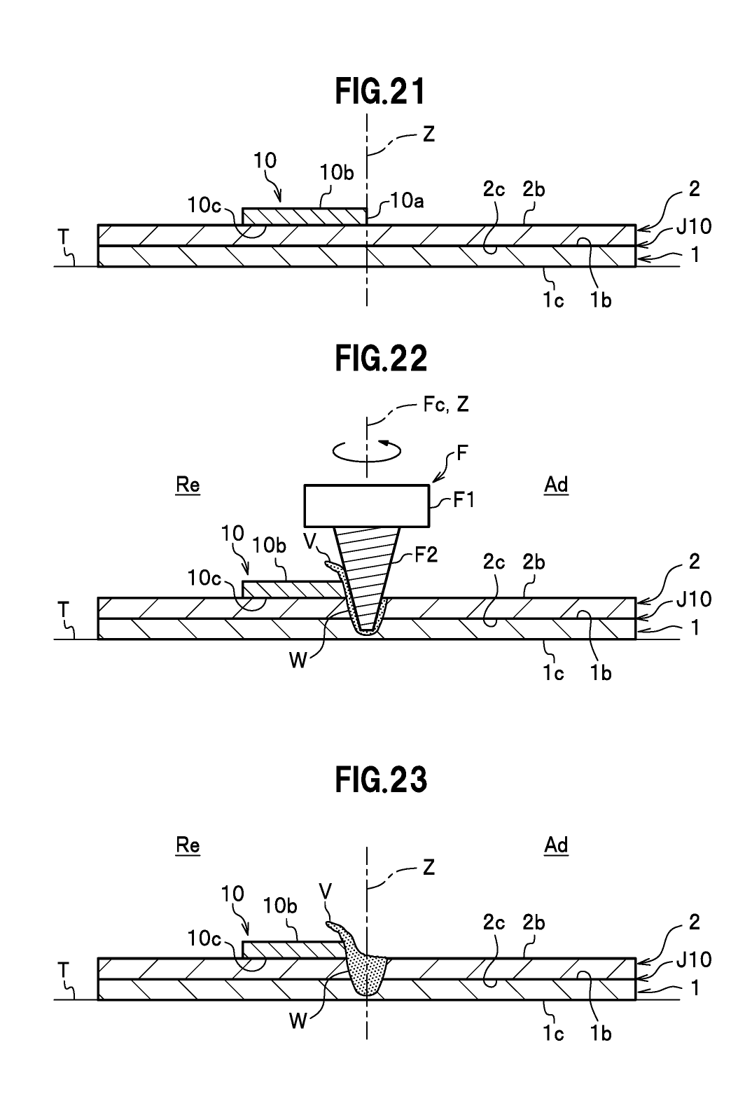

As shown in FIG. 21, in the overlaying step, the first metal member 1 is overlaid with the second metal member 2. The first metal member 1 and the second metal member 2 are metal plate members. The thicknesses of the first metal member 1 and the second metal member 2 are the same. Thicknesses of the first metal member 1 and the second metal member 2 may be set appropriately. In the overlaying step, the front surface 1b of the first metal member 1 is overlaid with the rear surface 2c of the metal member 2 to form an overlaid portion J10.

In the arranging step, the auxiliary member 10 is arranged on the second metal member 2. The auxiliary member 10 is a metal plate member. The auxiliary member 10 is not particularly limited as long as it is a frictional stirrable metal, and, in the present embodiment, is made of the same material as the first metal member 1 and the second metal member 2. The thickness of the auxiliary member 10 is appropriately set to prevent metal shortage in the plasticized region W after the frictional stirring step to be described later. In the present embodiment, the thickness of the auxiliary member 10 is set thinner than that of each of the first metal member 1 and the second metal member 2.

In the arranging step, the rear surface 10c of the auxiliary member 10 is brought in contact with the front surface 2b of the second metal member 2. Further, the first metal member 1, the second metal member 2 and the auxiliary member 10 are immovably fixed to the frame T with the jig (not shown). Note that, in the present embodiment, the auxiliary member 10 is in a plate shape, but may have another shape.

As shown in FIG. 22, in the frictional stirring step, the overlaid portion J10 between the first metal member 1 and the second metal member 2 is joined by frictional stirring with the joining rotary tool F. The joining rotary tool F has the coupling portion F1 and the stirring pin F2. The joining rotary tool F corresponds to the “rotary tool” in the appended claims. In the present embodiment, since the joining rotary tool F is rotated counterclockwise, the spiral groove is formed clockwise from the base end toward the distal end. In other words, the spiral groove can be traced from the base end toward the distal end to find that it is formed clockwise as viewed from above.

This reduces the amount of metal overflowed out of the joined metal members (first metal member 1, second metal member 2 and auxiliary member 10). The spiral groove may be omitted.

In the frictional stirring step, only the stirring pin F2 rotated counterclockwise is inserted in the overlaid portion J10 and then relatively moved while the coupling portion F1 is kept away from the joined metal members. In other words, the base end of the stirring pin F2 is kept exposed during frictional stir joining. Here, as shown in FIG. 21, a line that runs across the end surface 10a of the auxiliary member 10 and is orthogonal to the first metal member 1 and the second metal member 2 is referred to as a reference line Z. In the frictional stirring step, the joining rotary tool F is relatively moved in a state that the rotation axis Fc of the joining rotary tool F is in line with the reference line Z and the stirring pin F2 is in contact with the first metal member 1, the second metal member 2 and the auxiliary member 10.

In the present embodiment, the joining rotary tool F is set to travel such that the auxiliary member 10 is positioned at the left in the traveling direction of the joining rotary tool F. The rotating direction and the traveling direction of the joining rotary tool F is not limited to those as described above and may be set appropriately. For example, the joining rotary tool F may be rotated clockwise while the auxiliary member 10 is arranged at the left in the traveling direction of the joining rotary tool F. Alternatively, the joining rotary tool F may be rotated in either direction while the auxiliary member 10 is arranged at the right in the traveling direction of the joining rotary tool F. A condition such as a rotating direction of the joining rotary tool F and a preferable positional relationship with the auxiliary member 10 will be described later.

An insertion depth of the stirring pin F2 is set such that, in the present embodiment, the stirring pin F2 reaches the first metal member 1. Note that the overlaid portion J10 may be frictionally stirred in the state that the stirring pin F2 is in contact with only the second metal member 2 and the auxiliary member 10. In this case, the overlaid portion J10 is plastically fluidized for joining by frictional heat between the stirring pin F2 and the second metal member 2 and the auxiliary member 10. The plasticized region W is generated on the track where the joining rotary tool F passed through. As shown in FIG. 23, after the frictional stirring step, the burrs V are generated on the end portion of the auxiliary member 10.

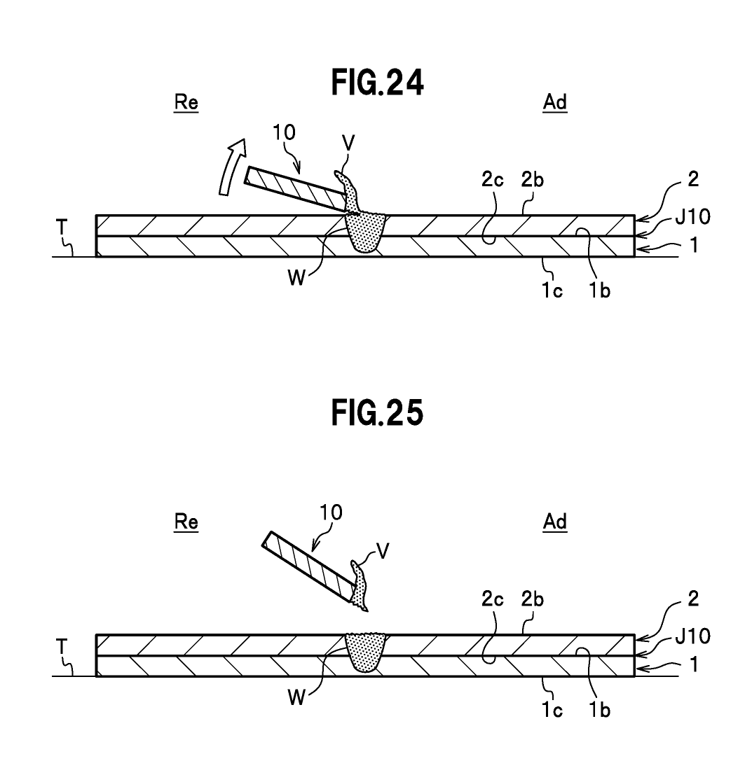

As shown in FIGS. 24 and 25, in the removing step, the auxiliary member 10 is removed from the second metal member 2. In the removing step, the auxiliary member 10 is folded toward a direction away from the second metal member 2, for example, manually and then removed from the second metal member 2. Accordingly, as shown in FIG. 25, the first metal member 1 is joined with the second metal member 2 in a thickness direction.

According to the joining method of the present embodiment described above, when the first metal member 1 is joined with the second metal member 2, the auxiliary member 10 is also joined by frictional stirring. This prevents metal shortage in the joined portion (plasticized region W), to prevent any recessed groove from being formed in the front surface 2b of the second metal member 2.

Further, according to the present embodiment, the burrs V are generated on the auxiliary member 10 in the frictional stirring step, but are removed together with the whole auxiliary member 10 in the removing step. Thus, the burrs are easily removed. As shown in FIG. 23, after the frictional stirring step, the end surface of the auxiliary member 10 becomes thinner toward the center of the plasticized region W. The auxiliary member 10 may be removed with the removing device or the like, but is removed easily manually in the present embodiment.

Here, in the joining method according to the present embodiment, the auxiliary member 10 is set to be thinner than the first metal member 1 and the second metal member 2. If the shoulder portion of the rotary tool is pressed against the metal members for frictional stirring as in a conventional method, the shoulder portion is brought in contact with the auxiliary member 10, to cause the auxiliary member 10 to be scattered outside, so that metal shortage in the joined portion is not compensated. In contrast, in the present embodiment, since only the stirring pin F2 of the joining rotary tool F is brought in contact with the first metal member 1, the second metal member 2 and the auxiliary member 10 for frictional stirring, the auxiliary member 10 is not scattered outside, so that the metal shortage in the joined portion is compensated. Further, a load applied to the frictional stir device is reduced as compared with the case where the shoulder portion is contacted.

Further, as shown in FIG. 22, in the frictional stirring step according to the present embodiment, the auxiliary member 10 is arranged at the left in the traveling direction and the joining rotary tool F is rotated counterclockwise, to set the auxiliary member 10 to be on the Re side.

In the present embodiment, since the rotating speed of the joining rotary tool F is set to be fast, the burrs V are generated on the Re side, that is, on the auxiliary member 10. In other words, in the present embodiment, the joining condition of the joining rotary tool F is set such that the burrs V are generated more on the auxiliary member 10. Accordingly, the burrs V generated on the auxiliary member 10 are removed together with the whole auxiliary member 10, to facilitate the burr removing step. Further, setting the rotating speed of the joining rotary tool F to be fast allows the moving speed (feeding speed) of the joining rotary tool F to be increased. This shortens a joining cycle.

As described above, in the frictional stirring step, it depends on the joining condition on which side of the traveling direction of the joining rotary tool F the burrs V are generated. Depending on the joining condition, the auxiliary member 10 is arranged on the side on which the burrs V are generated or are generated more, to facilitate the burr removing step.

### Seventh Embodiment

Next, a description will be given of the joining method according to a seventh embodiment. The joining method according to the seventh embodiment differs from the sixth embodiment in that the joining rotary tool F is inserted from the center of the auxiliary member 10. The joining method according to the seventh embodiment will be described, focusing on the difference from the sixth embodiment.

The joining method according to the present embodiment includes the overlaying step, the arranging step, the frictional stirring step and the removing step. The overlaying step is the same as that in the sixth embodiment, and the description thereof will be omitted. In the arranging step, the auxiliary member 10 is arranged on the front surface 2b of the second metal member 2.

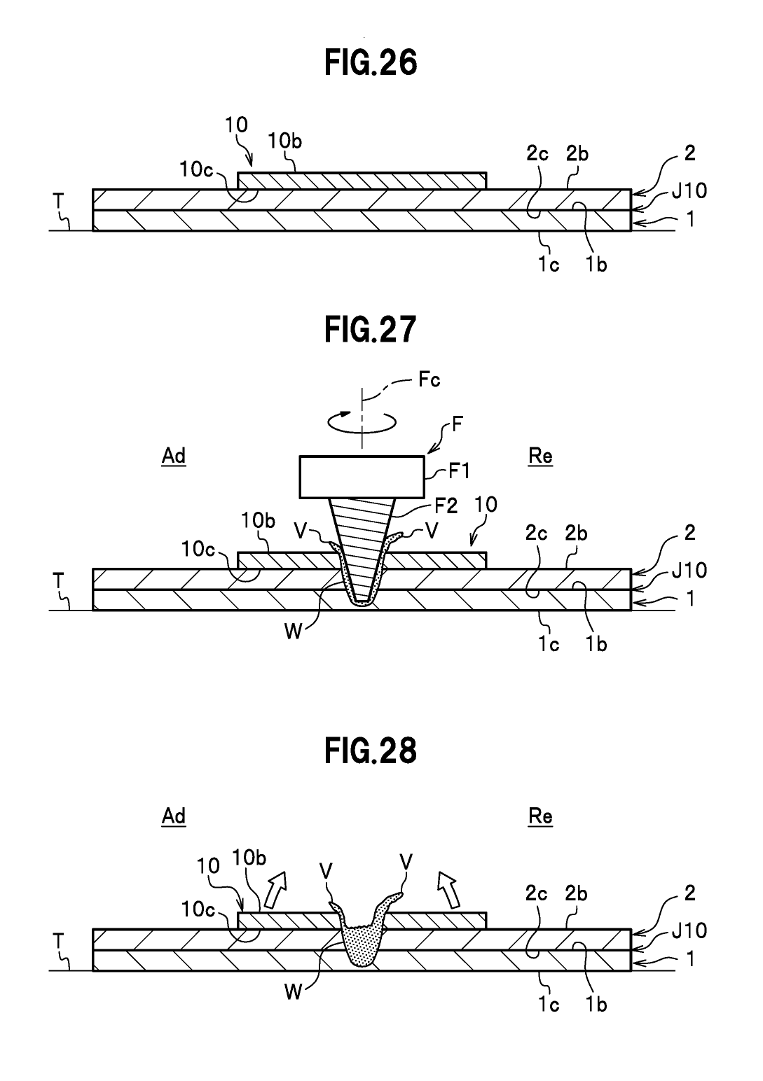

As shown in FIG. 26, in the arranging step, the rear surface 10c of the auxiliary member 10 is brought in contact with the front surface 2b of the second metal member 2. The thickness of the auxiliary member 10 is appropriately set to prevent metal shortage in the plasticized region W after the frictional stirring step to be described later. Further, the first metal member 1, the second metal member 2 and the auxiliary member 10 are immovably fixed with the jig (not shown).

As shown in FIG. 27, in the frictional stirring step, the overlaid portion J10 between the first metal member 1 and the second metal member 2 is joined by frictional stirring with the joining rotary tool F. In the frictional stirring step, the stirring pin F2 rotated clockwise is inserted from the center of the front surface 10b of the auxiliary member 10, to set the insertion depth of the stirring pin F2 so as to reach the first metal member 1. In the frictional stirring step, only the stirring pin F2 rotated clockwise is inserted in the overlaid portion J10 and then moved while the coupling portion F1 is kept away from the joined metal members. In other words, the base end of the stirring pin F2 is kept exposed during frictional stir joining. In the present embodiment, since the joining rotary tool F is rotated clockwise, the spiral groove of the stirring pin F2 is formed counterclockwise from the base end toward the distal end.

In the state that the stirring pin F2 is in contact with the first metal member 1, the second metal member 2 and the auxiliary member 10, the joining rotary tool F is relatively moved in the overlaid portion J10. Accordingly, the overlaid portion J10 is joined by frictional stirring. The plasticized region W is formed on the trace on which the joining rotary tool F has passed. Note that, in the present embodiment, since the joining rotary tool F is rotated at a high speed, the burrs tend to be generated more on the Re side than the Ad side. Further, as in the case of the sixth embodiment, the stirring pin F2 may be brought in contact with only the second metal member 2 and the auxiliary member 10 (so as not to reach the first metal member 1) for frictional stirring.

As shown in FIG. 28, in the removing step, the auxiliary member 10 divided in the frictional stirring step is removed from the first metal member 1 and the second metal member 2. In the removing step, each auxiliary member 10, 10 is folded toward a direction away from the second metal member 2 and then removed.

According to the joining method of the present embodiment described above, when the first metal member 1 is joined with the second metal member 2, the auxiliary member 10 is also joined by frictional stirring. This prevents metal shortage in the joined portion (plasticized region W). Further, since the stirring pin F2 is inserted from the center of the auxiliary member 10, the metal shortage in the joined portion (plasticized region W) is prevented more reliably, and the metal is replenished in a well-balanced manner. Still further, since the center of the auxiliary member 10 is flat, the stirring pin F2 is easily inserted in the auxiliary member 10.

According to the present embodiment, the burrs V, V are generated on each part of the auxiliary member 10, 10 divided in the frictional stirring step, but are removed together with the whole auxiliary member 10 in the removing step. Thus, the burrs are easily removed. The auxiliary member 10 may be removed with the removing device, but is easily removed manually in the present embodiment.

### Eighth Embodiment

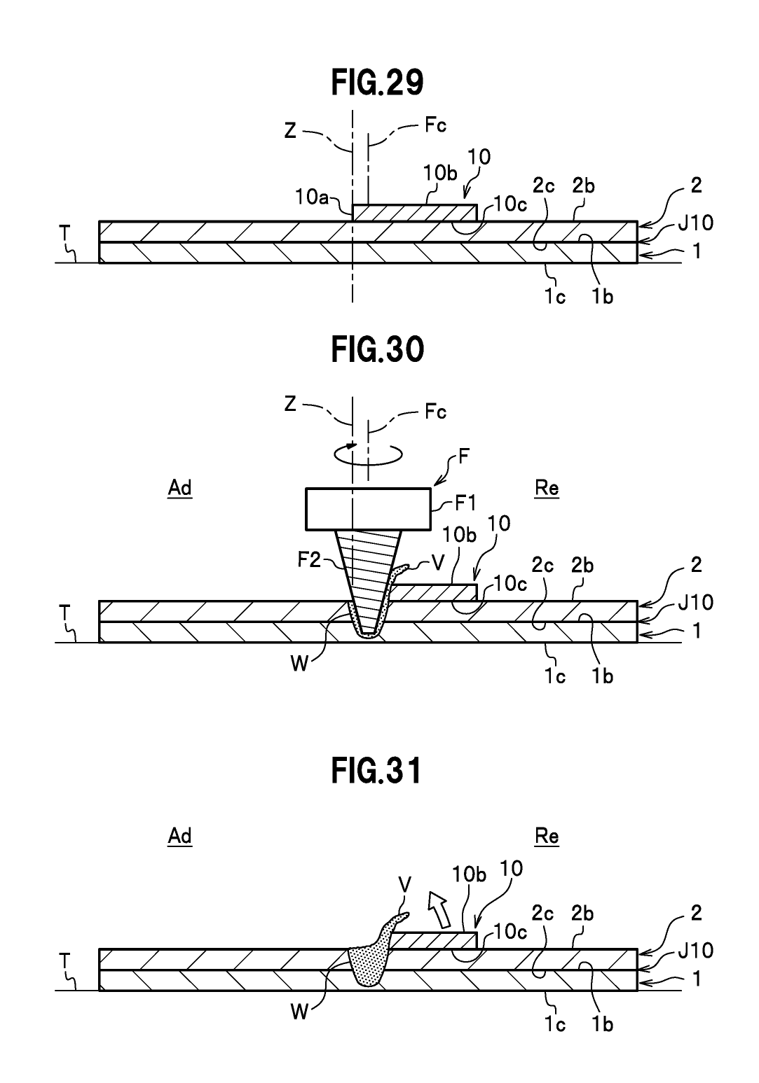

Next, a description will be given of the joining method according to an eighth embodiment. As shown in FIGS. 29 and 30, the joining method according to the eighth embodiment mainly differs from the sixth embodiment in terms of an insertion position of the stirring pin F2. The joining method according to the eighth embodiment will be described, focusing on the difference from the sixth embodiment. The joining method according to the eighth embodiment includes the overlaying step, the arranging step, the frictional stirring step and the removing step.

The overlaying step is the same as that in the sixth embodiment and the description thereof will be omitted. As shown in FIG. 29, in the arranging step, the front surface 2b of the second metal member 2 is brought in contact with the rear surface 10c of the auxiliary member 10. In the present embodiment, the auxiliary member 10 is arranged at the right in the traveling direction of the joining rotary tool F.

As shown in FIG. 30, in the frictional stirring step, the overlaid portion J10 between the first metal member 1 and the second metal member 2 is joined by frictional stirring with the joining rotary tool F. In the present embodiment, since the joining rotary tool F is rotated clockwise, the spiral groove of the stirring pin F2 is formed counterclockwise from the base end toward the distal end.

In the frictional stir step, while the rotation axis Fc of the joining rotary tool F is positioned slightly toward the center of the auxiliary member 10 with respect to the reference line Z, only the stirring pin F2 rotated clockwise is inserted in the overlaid portion J10. Then, while the coupling portion F1 is kept away from the joined metal members, the joining rotary tool F is relatively moved from the near side toward the far side in FIG. 30. In the present embodiment, the joining rotary tool F is set to travel such that the auxiliary member 10 is arranged at the right in the traveling direction of the joining rotary tool F and the joining rotary tool F is rotated at a high speed. Accordingly, in the present embodiment, the auxiliary member 10 is set to be on the Re side and the burrs V are generated more on the auxiliary member 10. The insertion position (distance between the rotation axis Fc of the joining rotary tool F and the reference line Z) of the joining rotary tool F in this embodiment is appropriately controlled such that the auxiliary member 10 is left on only one side of the joining rotary tool F after the frictional stirring step.

As shown in FIG. 31, in the removing step, the auxiliary member 10 is removed from the second metal member 2. In the removing step, the auxiliary member 10 is folded toward a direction away from the second metal member 2 manually, for example, and then removed from the second metal member 2.

According to the joining method of the present embodiment described above, when the first metal member 1 is joined with the second metal member 2, the auxiliary member 10 is also joined by frictional stirring, to prevent metal shortage in the joined portion (plasticized region W).

Further, according to the joining condition of the present embodiment, since the rotating speed of the joining rotary tool F is set to be fast, the burrs V tend to be generated more on the Re side. In other words, in the present invention, the rotating direction and traveling direction of the joining rotary tool F and the like (joining condition) are set such that the burrs V are generated more on the auxiliary member 10. Accordingly, the burrs V generated on the auxiliary member 10 are removed together with the whole auxiliary member 10, to facilitate the burr removing step. Further, as shown in FIG. 31, after the frictional stirring step, the end surface of the auxiliary member 10 becomes thinner toward the center of the plasticized region W. The auxiliary member 10 may be removed with the removing device or the like, but is easily removed manually in the present embodiment.

Here, in the removing step in the seventh embodiment described above, each auxiliary member 10, 10 on both sides of the center of the plasticized region W needs to be removed. However, in the present embodiment, the auxiliary member 10 is arranged so as not to be left on one side (left side in the traveling direction of the joining rotary tool F) after the frictional stirring step. Therefore, only the auxiliary member 10 left on the other side needs to be removed in the removing step. Accordingly, a work in the removing step is reduced. Further, since the rotation axis Fc is slightly shifted toward the center of the auxiliary member 10 with respect to the reference line Z, metal shortage in the joined portion is reliably prevented in a well-balanced manner. Still further, since the rotation axis Fc is slightly shifted toward the center of the auxiliary member 10 with respect to the reference line Z, the stirring pin F2 is easily inserted in the auxiliary member 10.

The embodiment of the present invention has been described above, but may be modified appropriately within the scope not departing from the spirit of the present invention. For example, the removing step is included in the embodiments, but the auxiliary member 10 may not be removed and may be left as is on the second metal member 2.

### Ninth Embodiment

A description will be given in detail of the joining method according to a ninth embodiment of the present invention with reference to the drawings. The joining method according to the present embodiment includes the overlaying step, the arranging step, the frictional stirring step and the removing step.

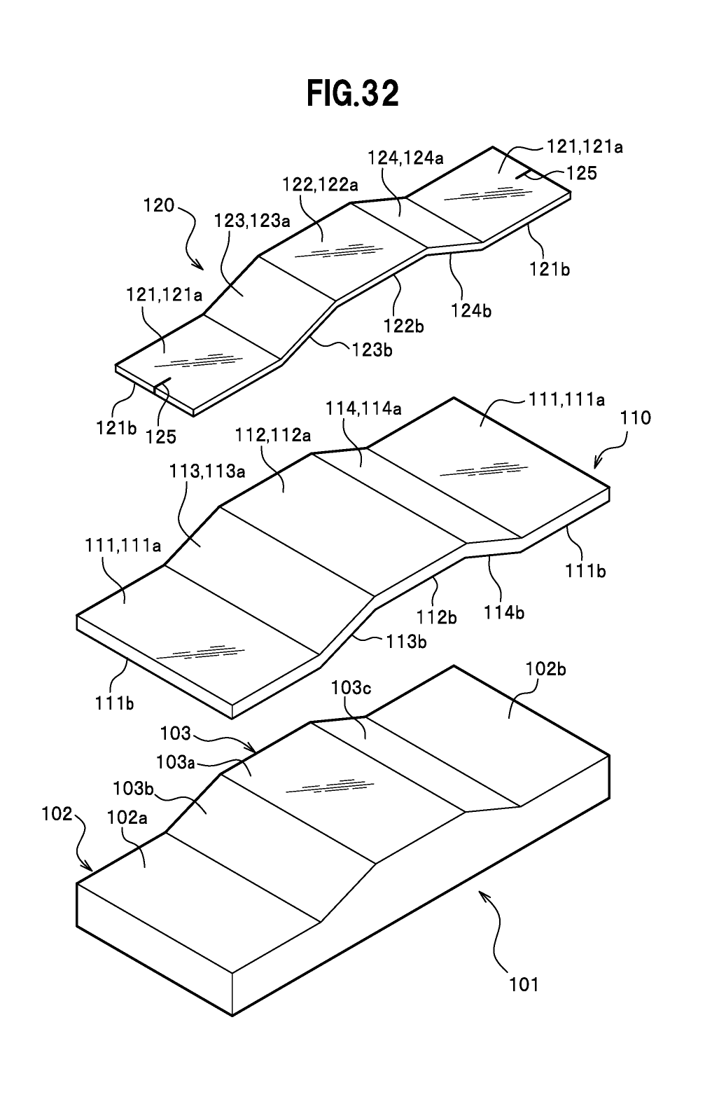

As shown in FIG. 32, in the overlaying step, a first metal member 101 is overlaid with a second metal member 110. The first metal member 101 and the second metal member 110 are metal plate members. The material of the first metal member 101 and the second metal members 110 is not particularly limited as long as it is a frictional stirrable metal, and, may be appropriately selected from, for example, an aluminum, an aluminum alloy, a copper, a copper alloy, a titanium, a titanium alloy, a magnesium, a magnesium alloy, etc. The first metal member 101 is thicker than the second metal member 110.

The first metal member 101 includes a body portion 102 in a rectangular parallelepiped and a convex portion 103 that is formed on the body portion 102 and has a trapezoidal cross section. A front surface 103a of the convex portion 103 is positioned higher than front surfaces 102a, 102b of the body portion 102. A first front surface 103b of the convex portion 103 is inclined to connect the front surface 102a of the body portion 102 with the front surface 103a of the convex portion 103. Further, a second front surface 103c of the convex portion 103 is inclined to connect the front surface 102b of the body portion 102 with the front surface 103a of the convex portion 103.

The second metal member 110 is a plate member that is thinner than the first metal member 101 and has a varying height in a constant thickness. The second metal member 110 includes base portions 111, 111, a central portion 112 and inclined portions 113, 114. The central portion 112 is formed higher than the base portions 111, 111 at the center between the base portions 111, 111. The inclined portion 113 connects one base portion 111 with the central portion 112 at an angle. The inclined portion 114 connects the other base portion 111 and the central portion 112 at an angle.

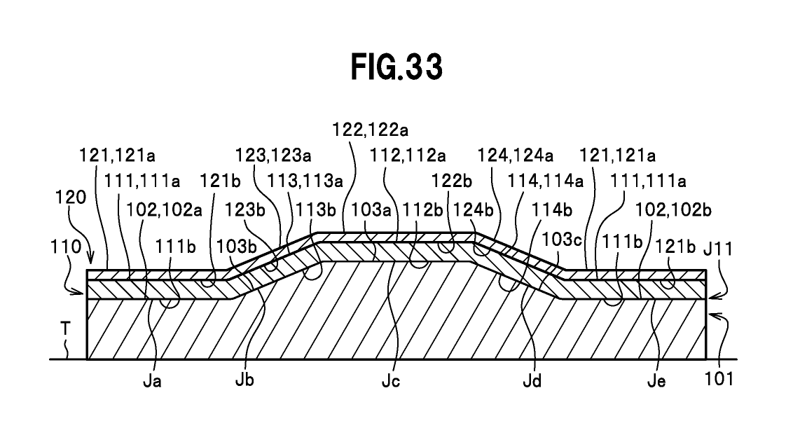

As shown in FIG. 33, in the overlaying step, the front surface of the first metal member 101 is overlaid with the rear surface of the second metal member 110 to form an overlaid portion J11. More specifically, the front surfaces 102a, 102b of the body portion 102 are overlaid with the rear surfaces 111b, 111b of the base portions 111, 111, and the front surface 103a of the convex portion 103 is overlaid with a rear surface 112b of the central portion 112. Further, the first front surface 103b of the convex portion 103 is overlaid with a rear surface 113b of the inclined portion 113, and second front surface 103c of the convex portion 103 is overlaid with a rear surface 114b of the inclined portion 114.

The first metal member 101 is overlaid with the second metal member 110 without having any gap. The overlaid portion J11 is formed to have a varying height. In other words, supposing that the height (elevation) at a start point (insertion position) for frictional stirring is referred to as a reference height, the overlaid portion J11 has portions having different heights from the reference height between the start point and an end point. In the present embodiment, the overlaid portion J11 includes a first flat portion Ja, a first inclined portion Jb, a second flat portion Jc, a second inclined portion Jd and a third flat portion Je.

As shown in FIG. 32, in the arranging step, an auxiliary member 120 is arranged on the second metal member 110. The auxiliary member 120 is a metal plate member. The auxiliary member 120 is not particularly limited as long as it is a frictional stirrable metal. In the present embodiment, the auxiliary member 120 is made of the same material as the first metal member 101 and the second metal member 110. The thickness of the auxiliary member 120 is appropriately set to prevent metal shortage in the plasticized region W after the frictional stirring step to be described later. In the present embodiment, the auxiliary member 120 is set to be thinner than the second metal member 110.

The auxiliary member 120 is a plate member having a varying height in a constant thickness. The auxiliary member 120 includes base portions 121, 121, a central portion 122, and inclined portions 123, 124. The central portion 122 is formed higher than the base portions 121,121 at the center between the base portions 121, 121. The inclined portion 123 connects one base portion 121 with the central portion 122 at an angle. The inclined portion 124 connects the other base portion 121 with the central portion 122 at an angle. Further, slits 125, 125 are formed at the center on respective ends of the base portion 121, 121.

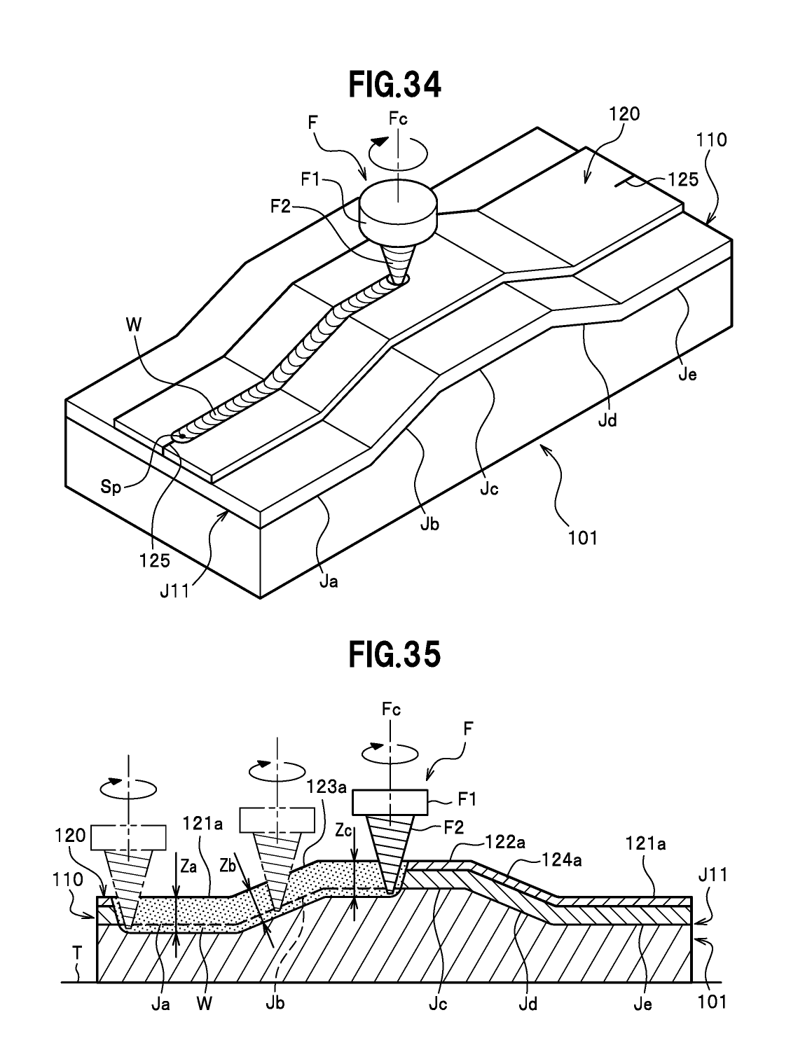

As shown in FIG. 34, in the arranging step, the rear surface of the auxiliary member 120 is brought in contact with the front surface of the second metal member 110, along the central portion of the second metal member 110 in the longitudinal direction. More specifically, as shown in FIG. 33, front surfaces 111a, 111a of the base portions 111, 111 of the second metal member 110 are overlaid with rear surfaces 121b, 121b of the base portions 121, 121 of the auxiliary member 120, and a front surface 112a of the central portion 112 is overlaid with a rear surface 122b of the central portion 122. Further, a first front surface 113a of the inclined portion 113 is overlaid with a rear surface 123b of the inclined portion 123, and a second front surface 114a of the inclined portion 114 is overlaid with a rear surface 124b of the inclined portion 124.

Still further, the first metal member 101, the second metal member 110 and the auxiliary member 120 are immovably fixed to the frame T with the jig (not shown). Note that the auxiliary member 120 is in a plate shape having a varying height, but may be in another shape.

As shown in FIG. 34, in the frictional stirring step, the overlaid portion J11 between the first metal member 101 and the second metal member 110 is joined by frictional stirring with the joining rotary tool F. The joining rotary tool F has the coupling portion F1 and the stirring pin F2. The joining rotary tool F corresponds to the “rotary tool” in the appended claims. In the present embodiment, since the joining rotary tool F is rotated clockwise, the spiral groove is formed counterclockwise from the base end toward the distal end. In other words, the spiral groove can be traced from the base end toward the distal end to find that it is formed counterclockwise as viewed from above.

The spiral groove formed in this way allows a plastically fluidized metal to be led toward the distal end of the stirring pin F2 via the spiral groove during frictional stirring. This reduces the amount of metal overflowed out of the joined metal members (first metal member 101, second metal member 110 and auxiliary member 120).

In the frictional stirring step, the stirring pin F2 of the joining rotary tool F rotated clockwise is inserted into the overlaid portion J11 shown in FIG. 35 from a start position Sp set on the front surface of the auxiliary member 120 shown in FIG. 34. In the present embodiment, an insertion depth of the stirring pin F2 is set to reach the first metal member 101. Further, the rotation axis of the joining rotary tool F is set to be always in parallel with the vertical axis for frictional stirring. Note that the overlaid portion J11 may be frictionally stirred with the stirring pin F2 only in contact with the second metal member 110 and the auxiliary member 120. In this case, the overlaid portion J11 is plastically fluidized for joining by frictional heat between the stirring pin F2 and the second metal member 110 and the auxiliary member 120. The plasticized region W is formed in the auxiliary member 120 on the trace on which the joining rotary tool F has passed.

In other words, as shown in FIG. 35, in the frictional stirring step, while the insertion depth of the stirring pin F2 to the overlaid portion J11 is approximately kept at constant, only the stirring pin F2 is in contact with the auxiliary member 120, the first metal member 101 and the second metal member 110 for frictional stirring. In the frictional stirring step according to the present embodiment, the joining rotary tool F is moved upward and downward on the front surface having a varying height (elevation) of the auxiliary member 120, with respect to the frame (not shown) to which the auxiliary member 120, the first metal member 101 and the second metal member 110 are fixed.

Accordingly, a depth Za of the plasticized region W in the first flat portion Ja, a depth Zb of the plasticized region W in the first inclined portion Jb (depth of the plasticized region W on a line orthogonal to a front surface 123a of an inclined surface 123), and a depth Zc of the plasticized region W in the second flat portion Jc are approximately the same. The “insertion depth” of the stirring pin F2 indicates the distance from the front surface of the auxiliary member 120 to the distal end of the stirring pin F2 on the rotation axis Fc of the joining rotary tool F.

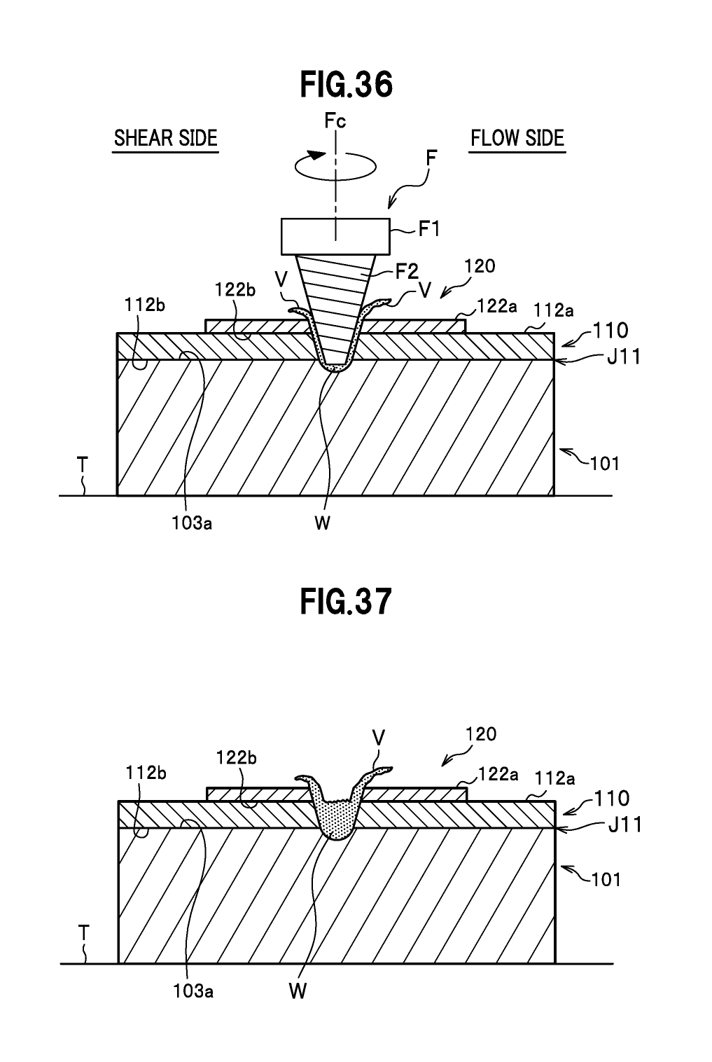

The frictional stirring is carried out around the stirring pin F2 in the frictional stirring step described above to join the first metal member 101 with the second metal member 110. At this time, as shown in FIGS. 36 and 37, the burrs V are generated on the front surface of the auxiliary member 120. Note that, in the present embodiment, since the joining rotary tool F is rotated at a high speed, the burrs tend to be generated more on the flow side than the shear side to be described later. The stirring pin F2 may be contacted with only the second metal member 110 and the auxiliary member 120 (so as not to reach the first metal member 101) for frictional stirring. In this case, the overlaid portion J11 is plastically fluidized for joining by frictional heat between the stirring pin F2 and the second metal member 110 and the auxiliary member 120.

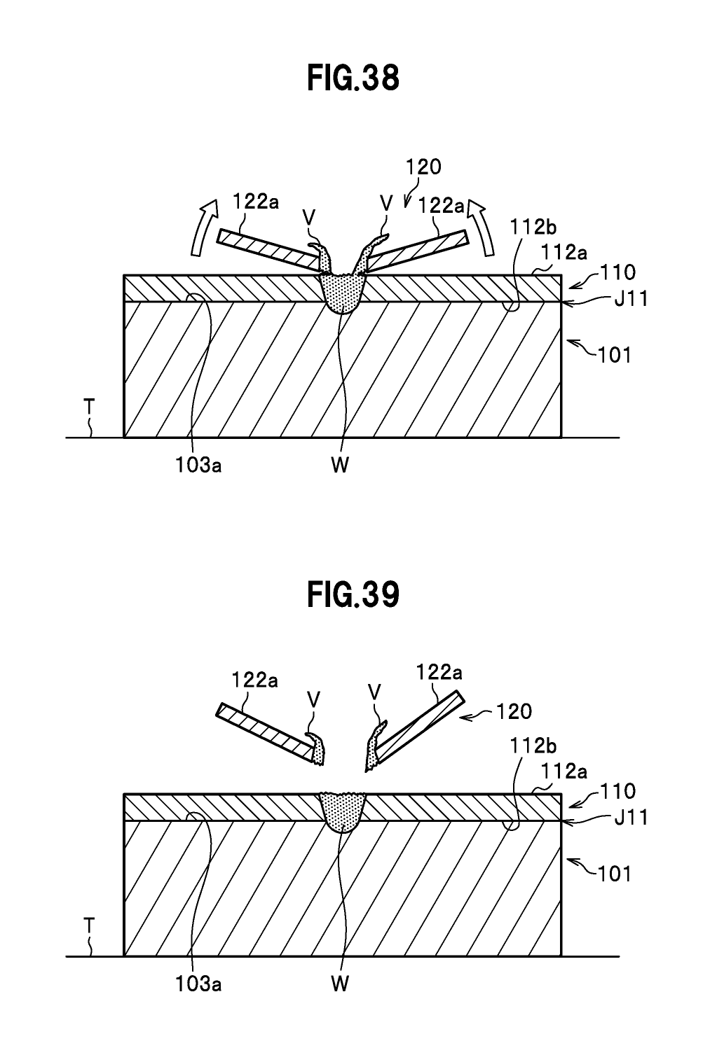

As shown in FIGS. 38 and 39, in the removing step, the auxiliary member 120 is removed from the second metal member 110. In the removing step, the auxiliary member 120 is folded toward a direction away from the second metal member 110 from both sides manually, for example, to be removed from the second metal member 110. At this time, the auxiliary member 120 is lifted from the end, with one of the slits 125, 125 (see FIG. 34) as a starting point, to be folded for removal.

According to the joining method of the present embodiment described above, when the first metal member 101 is joined with the second metal member 110, the auxiliary member 120 is also joined by frictional stirring. This prevents metal shortage in the joined portion (plasticized region W) to prevent the recessed groove from being formed in the front surface of the second metal member 110.

Further, since the stirring pin F2 is inserted from the center of the auxiliary member 120, metal shortage in the joined portion is prevented more reliably and a metal is replenished in a well-balanced manner. Still further, since the stirring pin F2 is inserted from the center of the auxiliary member 120, the stirring pin F2 is easily inserted in the auxiliary member 120.

Yet further, according to the present embodiment, the burrs V, V are generated on respective parts of the auxiliary member 120, 120 that are divided in the frictional stirring step, but are removed together with the whole auxiliary member 120, 120 in the removing step. Thus, the burrs are easily removed. The auxiliary member 120 may be removed with the removing device or the like, but is easily removed manually in the present embodiment.

Here, in the joining method according to the present embodiment, the auxiliary member 120 is set to be thinner than the first metal member 101 and the second metal member 110. If the shoulder portion of the rotary tool is pressed against the metal members for frictional stirring as in a conventional method, the shoulder portion is brought in contact with the auxiliary member 120, to cause the auxiliary member 120 to be scattered outside, so that metal shortage in the joined portion is not compensated. However, in the present embodiment, since only the stirring pin F2 of the joining rotary tool F is brought in contact with the first metal member 101, the second metal member 110 and the auxiliary member 120 for frictional stirring, the auxiliary member 120 is not scattered outside, so that metal shortage in the joined portion is compensated. Further, in the present invention, the overlaid portion J11 at a deeper position is joined with a reduced load applied to the frictional stir device as compared with the case where the shoulder portion of the rotary tool is contacted.

### [Modification]

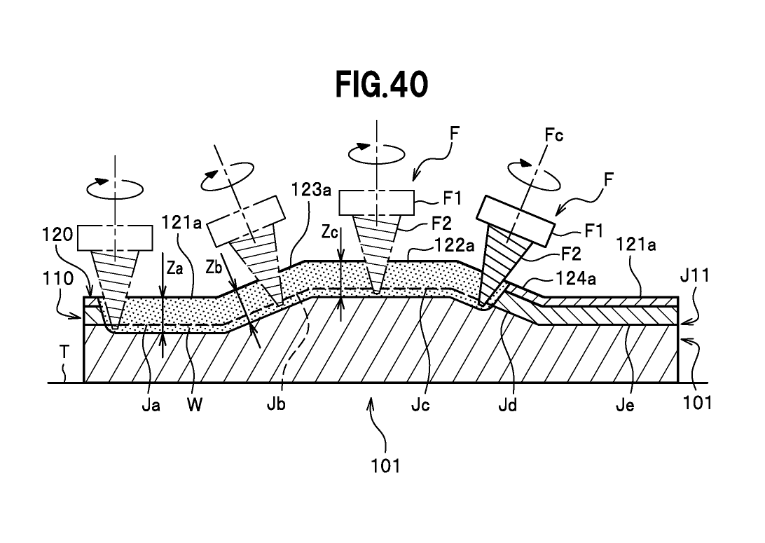

FIG. 40 is a sectional view showing a modified frictional stirring step of the joining method according to the ninth embodiment. As shown in FIG. 40, in the present modification, in the frictional stirring step, the joining rotation tool F is inserted vertically to the joined surface for frictional stirring. In the modified frictional stirring step, the rotation axis Fc of the joining rotary tool F is set to be in parallel with the vertical axis for frictional stirring, as in the ninth embodiment, on the first flat portion Ja, the second flat portion Jc and the third flat portion Je. In contrast, the joining rotary tool F is inclined with respect to the vertical axis on the first inclined portion Jb and the second inclined portion Jd to make the rotation axis Fc of the joining rotary tool F set to be in the vertical direction with respect to the joined surface between the first inclined portion Jb and the second inclined portion Jd for frictional stirring.

For executing the modification, the joining rotary tool F is preferably attached to a robot arm, for example, having a rotary drive device such as a spindle unit at the distal end. According to such a frictional stir device, the angle of the rotation axis Fc of joining rotary tool F is easily changed. Accordingly, even when the height of the overlaid portion J11 varies, the angle of the rotation axis Fc of joining rotary tool F with respect to the vertical axis is changed during frictional stirring, to make the joining rotary tool F always orthogonal to the joined surface for continuous frictional stirring.

Even in the modification described above, substantially the same advantageous effects as the ninth embodiment are obtained. Further, since the joining rotary tool F is inserted in each joined surface vertically, the overlaid portion J11 in an inclined surface is frictionally stirred to a deep position.

### Tenth Embodiment

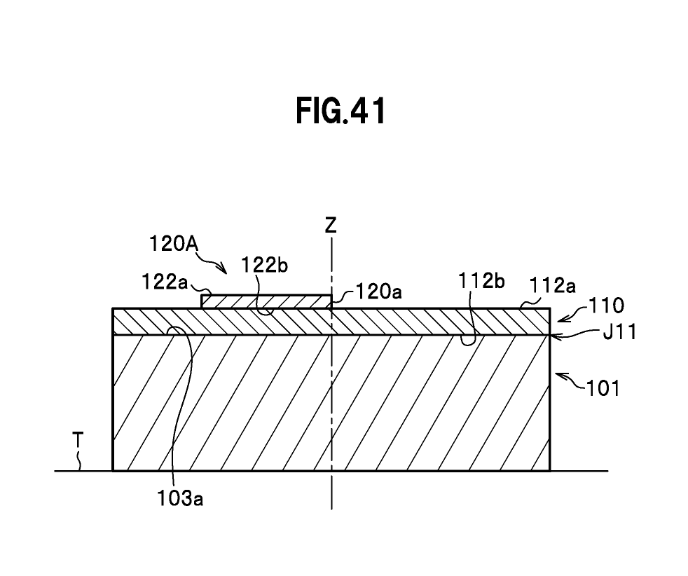

Next, a description will be given of the joining method according to a tenth embodiment. The joining method according to the tenth embodiment differs from the ninth embodiment in that the joining rotary tool F is inserted from an end surface 120a of an auxiliary member 120A shown in FIG. 41. Further, the slits 125, 125 are not formed in the auxiliary member 120A. The joining method according to the tenth embodiment will be described, focusing on the difference from the ninth embodiment.

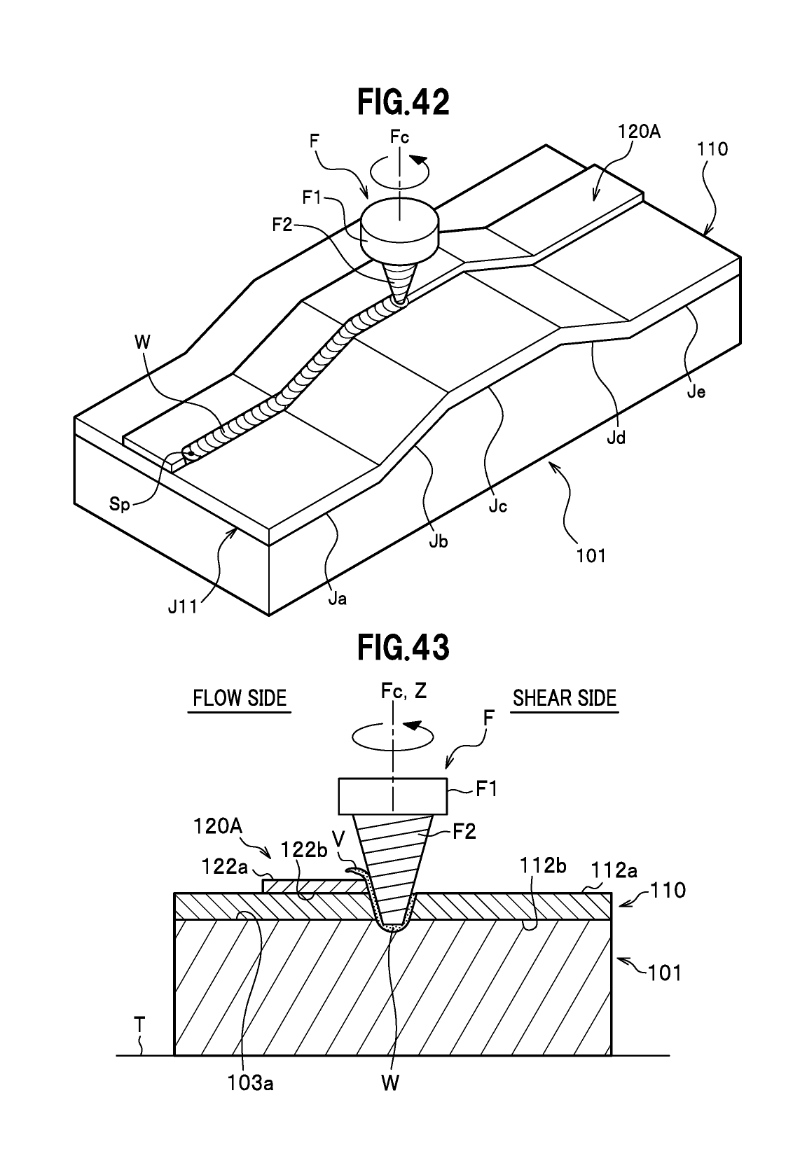

The joining method according to the present embodiment includes the overlaying step, the arranging step, the frictional stirring step and the removing step. Since the overlaying step is the same as that in the ninth embodiment, the description thereof will be omitted. As shown in FIGS. 41 and 42, in the arranging step, the auxiliary member 120A is arranged on the front surface of the second metal member 110, in the same manner as the ninth embodiment. The auxiliary member 120A in the tenth embodiment has a width about half the width of the auxiliary member 120 in the ninth embodiment.

As shown in FIGS. 42 and 43, in the frictional stirring step, the overlaid portion J11 between the first metal member 101 and the second metal member 110 is joined by frictional stirring with the joining rotary tool F. In the present embodiment, since the joining rotary tool F is rotated counterclockwise, the spiral groove of the stirring pin F2 is formed clockwise from the base end toward the distal end. In other words, the spiral groove can be traced from the base end toward the distal end to find that it is formed clockwise as viewed from above.

In the frictional stirring step, only the stirring pin F2 rotated counterclockwise is inserted and then relatively moved while the coupling portion F1 is kept away from the joined metal members. In other words, the base end of the stirring pin F2 is kept exposed during frictional stir joining. As shown in FIG. 41, the line that runs across the end surface 120a of the auxiliary member 120A and is orthogonal to the first metal member 101 and the second metal member 110 is referred to as the reference line Z. As shown in FIG. 42, in the frictional stirring step, the joining rotary tool F is relatively moved in a state that the rotation axis Fc of the joining rotary tool F is in line with the reference line Z and the stirring pin F2 is in contact with the first metal member 101, the second metal member 110 and the auxiliary member 120A.

In the present embodiment, the moving direction and the rotating direction of the joining rotary tool F is set such that the shear side of the joining rotary tool F (advancing side: side on which the moving speed of the rotary tool is added to the tangential speed on the circumference of the rotary tool) is located at the right in the traveling direction. The rotating direction and the traveling direction of the joining rotary tool F are not limited to those as described above and may be set appropriately.

In the present embodiment, since the rotating speed of the joining rotary tool F is set to be fast, as shown in FIG. 43, the burrs V tend to be generated more on the flow side (Re side) outside the plasticized region W. Further, setting the rotating speed of the joining rotary tool F to be fast allows the moving (feeding) speed of the joining rotary tool F to be increased. This shortens a joining cycle.

In the frictional stirring step, it depends on the joining condition on which side of the traveling direction of the joining rotary tool F the burrs V are generated. In the frictional stirring step, the joining condition is preferably set such that the burrs V are generated on the auxiliary member 120A.

An insertion depth of the stirring pin F2 is set, in the present embodiment, so as to reach the first metal member 101. Note that the overlaid portion J11 may be frictionally stirred with the stirring pin F2 being in contact with only the second metal member 110 and the auxiliary member 120A. In this case, the overlaid portion J11 is plastically fluidized for joining by frictional heat between the stirring pin F2 and the second metal member 110 and the auxiliary member 120A. The plasticized region W is formed on the trace on which the joining rotary tool F has passed.

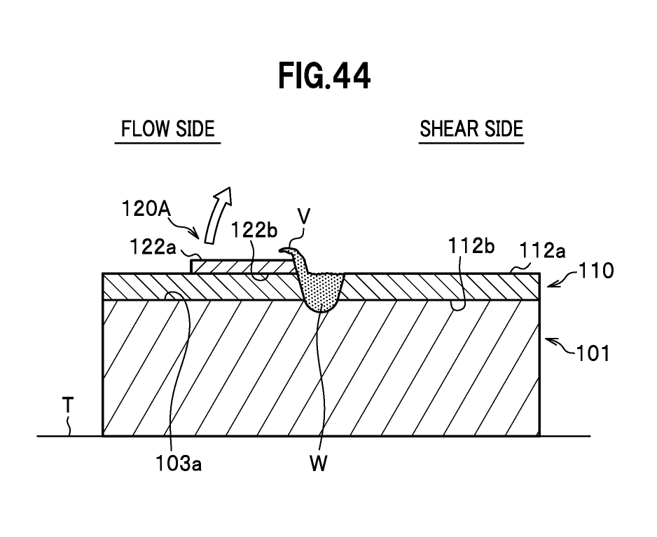

As shown in FIG. 44, in the removing step, the auxiliary member 120A is removed from the second metal member 110. In the removing step, the auxiliary member 120A is folded toward a direction, as shown by the arrow, away from the second metal member 110 manually, for example, to be removed from the second metal member 110. Accordingly, the first metal member 101 is joined with the second metal member 110 in a thickness direction.

According to the joining method of the present embodiment described above, when the first metal member 101 is joined with the second metal member 110, the auxiliary member 120A is also joined by frictional stirring. This prevents metal shortage in the joined portion (plasticized region W), to prevent any recessed groove from being formed in the front surface of the second metal member 110.

Further, according to the present embodiment, the burrs V are generated on the auxiliary member 120A in the frictional stirring step, but are removed together with the whole auxiliary member 120A in the removing step. Thus, the burrs are easily removed. The auxiliary member 120A may be removed with the removing device or the like, but is easily removed manually in the present embodiment.

### Eleventh Embodiment

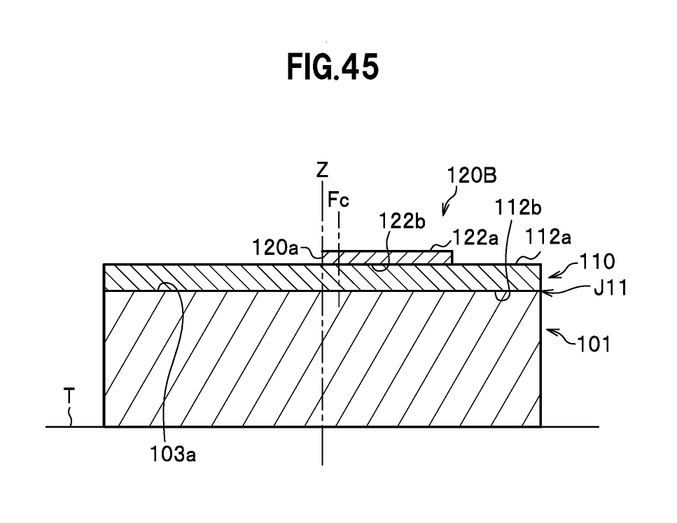

Next, a description will be given of the joining method according to an eleventh embodiment of the present invention. As shown in FIGS. 45 to 48, in the joining method according to the eleventh embodiment, the insertion position of the stirring pin F2 mainly differs from that in the tenth embodiment. The joining method according to the eleventh embodiment will be described, focusing on the difference from the tenth embodiment. The joining method according to the eleventh embodiment includes the overlaying step, the arranging step, the frictional stirring step and the removing step.

The overlaying step is the same as that in the tenth embodiment and the description thereof will be omitted. As shown in FIG. 45, in the arranging step, an auxiliary member 120B is arranged on the front surface of the second metal member 110 in the same manner as the ninth embodiment. The auxiliary member 120B has a width about half the width of the auxiliary member 120 in the ninth embodiment.

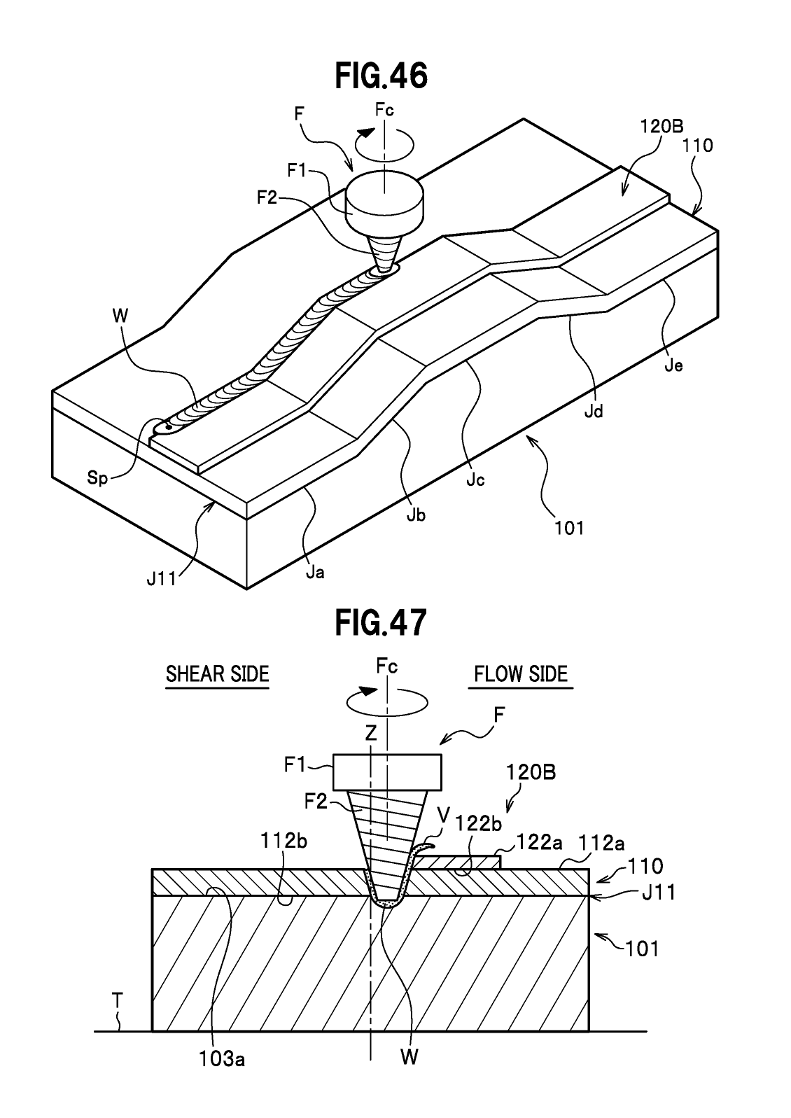

As shown in FIG. 46, in the frictional stirring step, the overlaid portion J11 between the first metal member 101 and the second metal member 110 is joined by frictional stirring with the joining rotary tool F. In the present embodiment, since the joining rotary tool F is rotated clockwise, the spiral groove of the stirring pin F2 is formed counterclockwise from the base end toward the distal end.

As shown in FIG. 45, in the frictional stirring step, while the rotation axis Fc of the joining rotary tool F is positioned slightly toward the center of the auxiliary member 120B with respect to the reference line Z running across the end surface 120a of the auxiliary member 120B, only the stirring pin F2 rotated clockwise is inserted in the overlaid portion J11. Then, the joining rotary tool F is relatively moved while the coupling portion F1 is kept away from the joined metal members. In the present embodiment, as shown in FIG. 46, the joining rotary tool F is set to travel such that the auxiliary member 120B is arranged at the right in the traveling direction of the joining rotary tool F, and then rotated at a high speed. Accordingly, in the present embodiment, as shown in FIG. 47, the auxiliary member 120B is set to be on the flow side (Re side) and the burrs V are generated on the auxiliary member 120B. The insertion position of the joining rotary tool F (distance between the rotation axis Fc of the joining rotary tool F and the reference line Z) in this embodiment is appropriately controlled such that the auxiliary member 120B remains only on one side of the joining rotary tool F after the frictional stirring step.

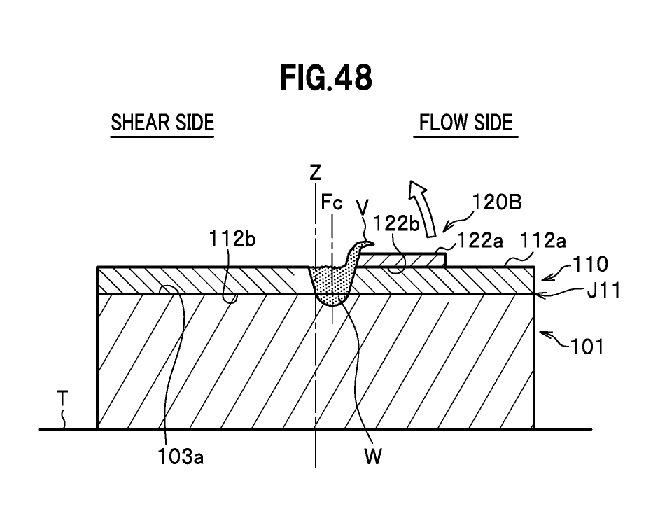

As shown in FIG. 48, in the removing step, the auxiliary member 120B is removed from the second metal member 110. In the removing step, the auxiliary member 120B is folded toward a direction (shown by the arrow) away from the second metal member 110 manually, for example, to be removed from the second metal member 110.

According to the joining method of the present embodiment described above, when the first metal member 101 is joined with the second metal member 110, the auxiliary member 120B is also joined by frictional stirring, to prevent metal shortage in the joined portion (plasticized region W).

Further, according to the joining condition of the present embodiment, since the rotating speed of the joining rotary tool F is set to be fast, the burrs V are generated more on the flow side. In other words, in the present invention, the rotating direction and the traveling direction (joining condition) of the joining rotary tool F and the like are set such that the burrs V are generated more on the auxiliary member 120B. Accordingly, the burrs V generated on the auxiliary member 120B are removed together with the whole auxiliary member 120B, to facilitate the burr removing step. Further, the auxiliary member 120B may be removed with the removing device or the like, but, is easily removed manually in the present embodiment.

Here, in the removing step in the ninth embodiment described above, parts of the auxiliary member 120, 120 on both sides of the plasticized region W need to be removed. However, in the present embodiment, the insertion position of the stirring pin F2 is controlled such that the auxiliary member 120B is not left on one side (left side in the traveling direction of the joining rotary tool F) after the frictional stirring step. Therefore, only a part of the auxiliary member 120B remaining on the other side needs to be removed in the removing step. Accordingly, a work in the removing step is reduced. Further, since the rotation axis Fc is slightly shifted toward the center of the auxiliary member 120B with respect to the reference line Z, metal shortage in the joined portion is reliably prevented in a well-balanced manner.

Still further, since the rotation axis Fc is slightly shifted toward the center of the auxiliary member 120B with respect to the reference line Z, the stirring pin F2 is easily inserted in the auxiliary member 120B.

### Alternative Embodiment

Next, a description will be given of an alternative embodiment of the present invention. The joining method according to another embodiment includes the overlaying step, the frictional stirring step and the removing step. The alternative embodiment differs from the ninth to eleventh embodiments in that the metal members are curved in the vertical direction.

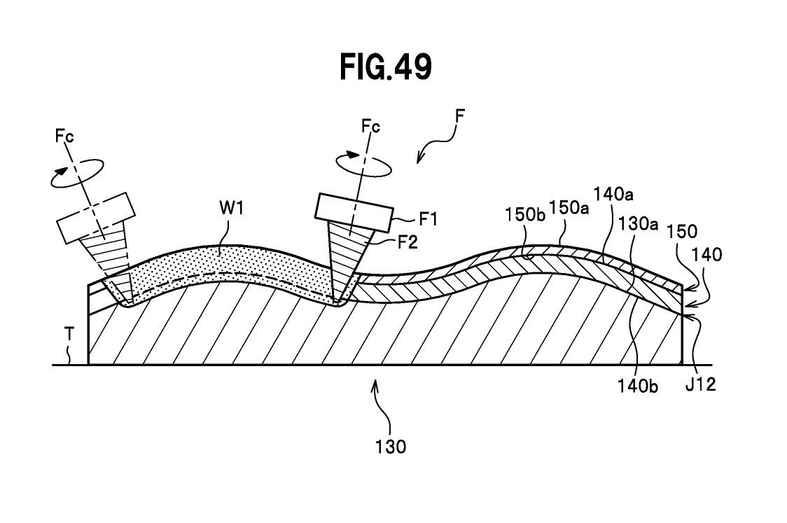

As shown in FIG. 49, in the overlaying step, a first metal member 130 is overlaid with a second metal member 140. The first metal member 130 and the second metal member 140 are formed of a frictional stirrable metal, and a front surface 130a of the first metal member 130 and a front surface 140a and a rear surface 140b of the plate-shaped second metal member 140 are formed in a curve having the same radius of curvature. The front surface 130a of the first metal member 130 is overlaid with the rear surface 140b of the second metal member 140 to form an overlaid portion J12.

In the arranging step, a rear surface 150b of a plate-shaped auxiliary member 150 that is curved to have the same shape as the second metal member 140 is brought in contact with the front surface 140a of the second metal member 140. Note that the first metal member 130, the second metal member 140 and the auxiliary member 150 are immovably fixed to the frame T with the jig (not shown).

In the frictional stirring step, the overlaid portion J12 is joined by frictional stirring with the joining rotary tool F. In the frictional stirring step, the stirring pin F2 of the joining rotary tool F is inserted from the front surface 150a of the auxiliary member 150 to the first metal member 130 through the second metal member 140, and the joining rotary tool F is relatively moved in the overlaid portion J12. In the frictional stirring step, the inclination angle of the joining rotary tool F is gradually changed such that the rotation axis Fc of joining rotary tool F is in line with each of the normal lines of the auxiliary member 150 and the second metal member 140. Further, in the frictional stirring step, an insertion depth of the stirring pin F2 is set to have the plasticized region W1 having a constant depth. The removing step is the same as that in the ninth embodiment and the description thereof will be omitted.

As the joining method according to alternative embodiment described above, even if the overlaid portion J12 is curved in the vertical direction to have a varying height, substantially the same advantageous effects as the ninth to eleventh embodiments are obtained.

The embodiments of the present invention have been described above, but may be appropriately modified in the scope not departing from the spirit of the present invention. For example, in the present embodiments, the removing step is included, but the auxiliary member may be left as is, without being removed, on the second metal member.

### Twelfth Embodiment

A description will be given in detail of the joining method according to the twelfth embodiment of the present invention with reference to the drawings. The joining method according to the present embodiment includes the butting step, the arranging step, the frictional stirring step and the removing step.

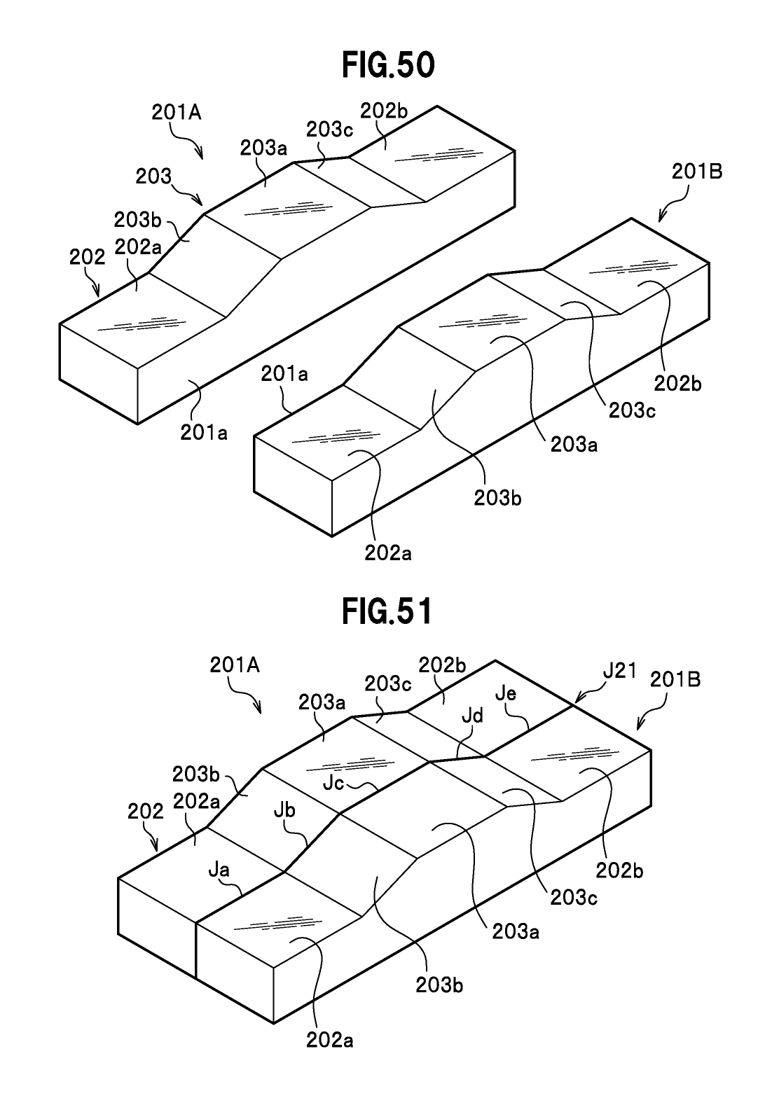

The joining method according to the twelfth embodiment will be described. In the present embodiment, an end surface 201a of the first metal member 201A and an end surface 201a of the second metal member 201B as shown in FIG. 50 are pressed against each other to form a butted portion J21 as shown in FIG. 51 which is joined by frictional stirring. The first metal member 201A and the second metal member 201B are metal members and have the end surfaces 201a, 201a to be butted in the same shape. Further, the first metal member 201A and the second metal member 201B are formed of the same material. The material is not limited as long as it is a frictionally stirrable metal, and may be selected from an aluminum, an aluminum alloy, a copper, a copper alloy, a titanium, a titanium alloy, a magnesium, a magnesium alloy or the like.

As shown in FIG. 50, the first metal member 201A and the second metal member 201B each includes a body portion 202 in a rectangular parallelepiped and a convex portion 203 that is formed on the body portion 202 and has a trapezoidal cross section. A front surface 203a of the convex portion 203 is positioned higher than front surfaces 202a, 202b of the body portion 202. A first front surface 203b of the convex portion 203 is inclined to connect the front surface 202a of the body portion 202 with the front surface 203a of the convex portion 203. Further, a second front surface 203c of the convex portion 203 is inclined to connect the front surface 202b of the body portion 202 with the front surface 203a of the convex portion 203.

The joining method according to the present embodiment includes the butting step and the joining step. As shown in FIG. 50, in the butting step, the end surface 201a of the first metal member 201A is pressed against the end surface 201a of the second metal member 201B. In the butting step, the first metal member 201A is pressed against the second metal member 201B so that surfaces of the two are flush with each other.

As shown in FIG. 51, the end surfaces 201a, 201a are brought in contact with each other in the butting step to form the butted portion J21. The butted portion J21 is formed to a varying height. In other words, supposing that the height (elevation) at a start point (insertion position) for frictional stirring is referred to as a reference height, the butted portion J21 has portions having different heights from the reference height between the start point and an end point. In the present embodiment, the butted portion J21 includes the first flat portion Ja, the first inclined portion Jb, the second flat portion Jc, the second inclined portion Jd and the third flat portion Je.

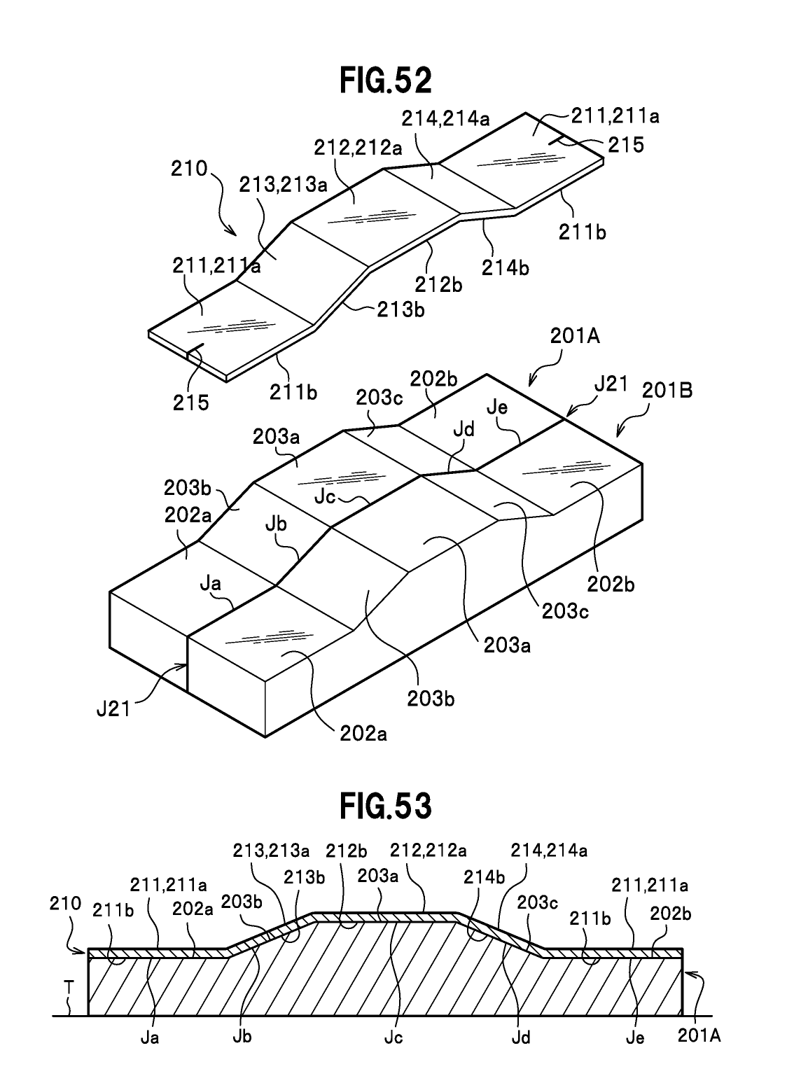

As shown in FIG. 52, in the arranging step, an auxiliary member 210 is arranged on the first metal member 201A and the second metal member 110 to be pressed against each other. The auxiliary member 210 is a metal plate member. The auxiliary member 210 is not particularly limited as long as it is a frictional stirrable metal. In the present embodiment, the auxiliary member 210 is made of the same material as the first metal member 201A and the second metal member 201B. The thickness of the auxiliary member 210 is appropriately set to prevent metal shortage in the plasticized region W after the frictional stirring step to be described later.

The auxiliary member 210 is a plate member that has a varying height in a constant thickness. The auxiliary member 210 includes base portions 221, 221, a central portion 212, and inclined portions 213, 214. The central portion 212 is formed to be positioned higher than the base portions 211,211 at the center between the base portions 211, 211. The inclined portion 213 connects one base portion 211 with the central portion 212 at an angle. The inclined portion 214 connects the other base portion 211 with the central portion 212 at an angle. Further, slits 215, 215 are formed at around the center on respective ends of the base portions 211, 211.

As shown in FIGS. 52 and 53, in the arranging step, the rear surface of the auxiliary member 210 is brought in contact with the center between the front surfaces of the first metal member 201A and the second metal member 201B, which are in a butted state. More specifically, the front surfaces 202a, 202b of the body portions 202 of the first metal member 201A and the second metal member 201B to be pressed against each other are overlaid with rear surfaces 211b, 211b of the base portions 211, 211 of the auxiliary member 210, and the front surface 203a of the convex portion 203 is overlaid with a rear surface 212b of the central portion 212. Further, the inclined first front surface 203b of the convex portion 203 is overlaid with a rear surface 213b of the inclined portion 213, and the inclined second front surface 203c of the convex portion 203 is overlaid with a rear surface 214b of the inclined portion 214.

Still further, the first metal member 201A and the second metal member 201B, which are in a butted state, and the auxiliary member 210 are immovably fixed to the frame T with the jig (not shown). Note that the auxiliary member 210 is in a plate shape having a varying height in the present embodiment, but may be in another shape as long as the auxiliary member 210 is in surface-contact with the front surfaces of the first metal member 201A and the second metal member 201B.

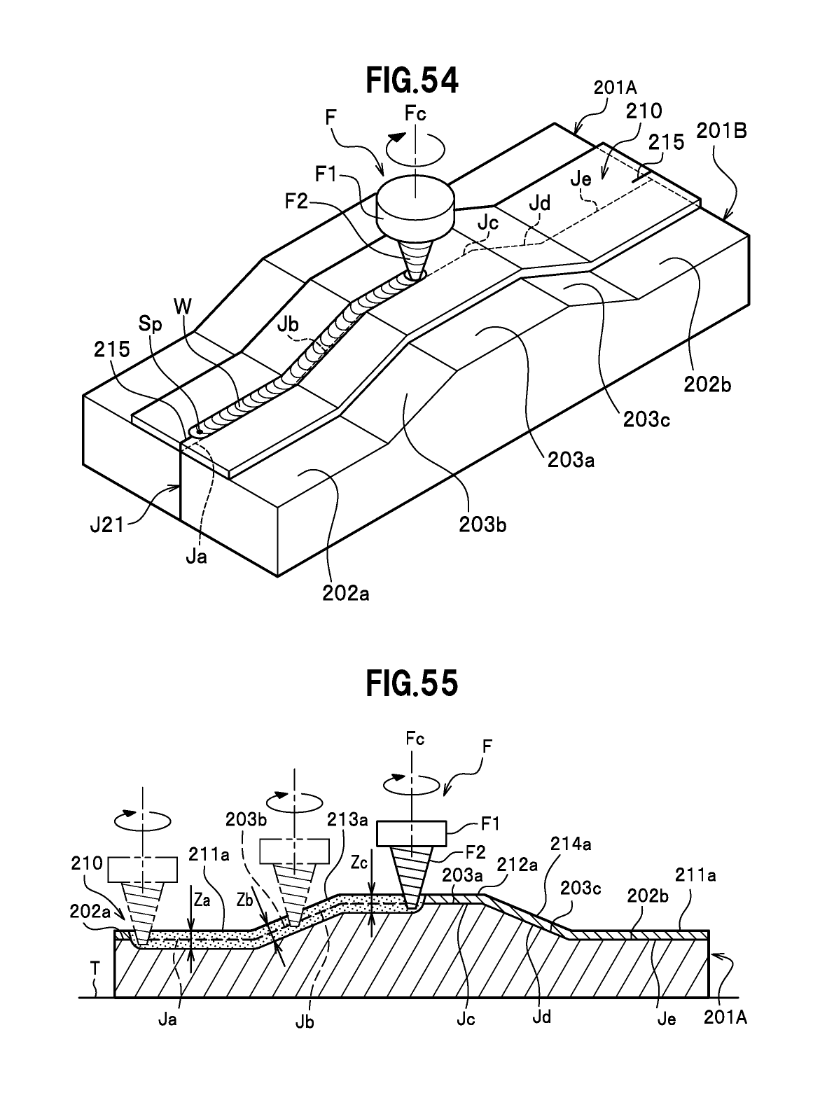

As shown in FIG. 54, in the frictional stirring step, the overlaid portion J21 between the first metal member 201A and the second metal member 201B, which are in a butted state, is joined by frictional stirring with the joining rotary tool F. The joining rotary tool F has the coupling portion F1 and the stirring pin F2. In the present embodiment, since the joining rotary tool F is rotated clockwise, the spiral groove is formed counterclockwise from the base end toward the distal end. In other words, the spiral groove can be traced from the base end toward the distal end to find that it is formed counterclockwise as viewed from above.

The spiral groove formed in this way allows a plastically fluidized metal to be led toward the distal end of the stirring pin F2 via the spiral groove during frictional stirring. This reduces the amount of metal overflowed out of the joined metal members (first metal member 201A and second metal member 201B which are in a butted state and auxiliary member 120).

As shown in FIG. 54, in the frictional stirring step, the stirring pin F2 of the joining rotary tool F rotated clockwise is inserted in the start position Sp set on the front surface of the auxiliary member 210. In the present embodiment, the insertion depth of the stirring pin F2 is set such that the stirring pin F2 contacts (reaches) the first metal member 201A and the second metal member 201B. Further, the rotation axis of the joining rotary tool F is set to be always in parallel with the vertical axis for frictional stirring. The first metal member 201A and the second metal member 201B are frictionally stirred around the stirring pin F2 in the frictional stirring step, to join the first metal member 201A and the second metal member 201B. The plasticized region W is formed on the trace on which the joining rotary tool F has passed.

In other words, as shown in FIG. 55, in the frictional stirring step, while the insertion depth of the stirring pin F2 in the overlaid portion J21 is kept at substantially constant, only the stirring pin F2 is in contact with the auxiliary member 210, the first metal member 201A and the second metal member 201B for frictional stirring. In the frictional stirring step according to the present embodiment, the joining rotary tool F is moved upward and downward on the front surface having a varying height (elevation) of the auxiliary member 210, with respect to the frame T to which the auxiliary member 210, the first metal member 201A and the second metal member 201B are fixed.

Accordingly, the depth Za of the plasticized region W in the first flat portion Ja, the depth Zb of the plasticized region W in the first inclined portion Jb (depth of the plasticized region W on a line orthogonal to a front surface 213a of an inclined portion 213), and the depth Zc of the plasticized region W in the second flat portion Jc are approximately the same. The “insertion depth” of the stirring pin F2 indicates the distance from the front surface of the auxiliary member 210 to the distal end of the stirring pin F2 on the rotation axis Fc of the joining rotary tool F.

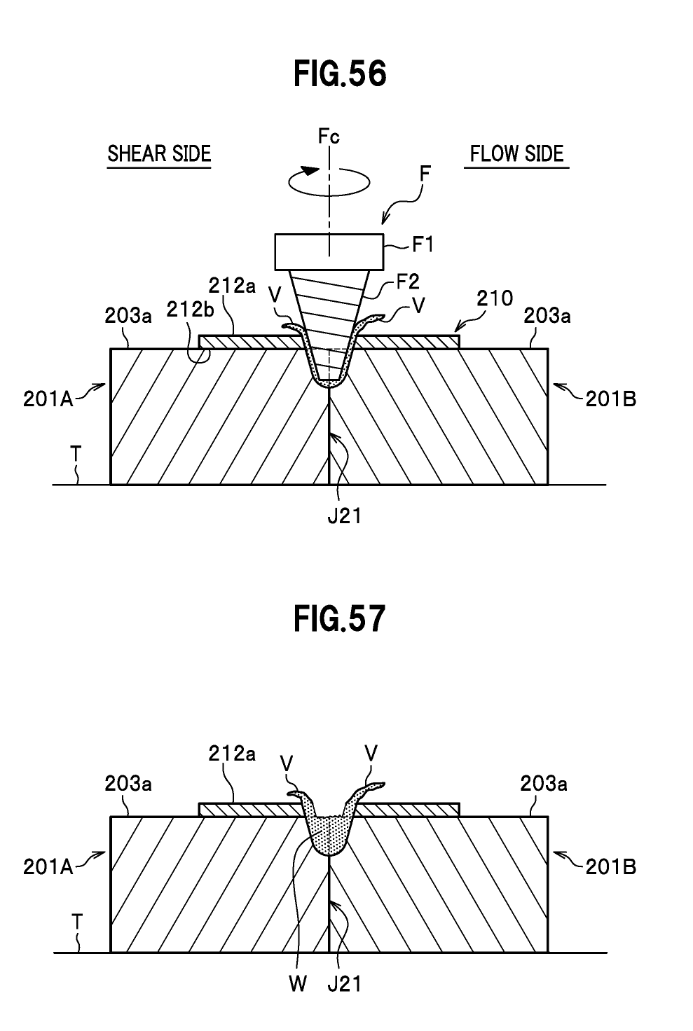

The frictional stirring is carried out around the stirring pin F2 in the frictional stirring step described above to join the first metal member 201A with the second metal member 201B. At this time, as shown in FIGS. 56 and 57, the burrs V are generated on the front surface of the auxiliary member 210. Note that, in the present embodiment, since the joining rotary tool F is rotated at a high speed, the burrs tend to be generated more on the flow side than the shear side to be described later.

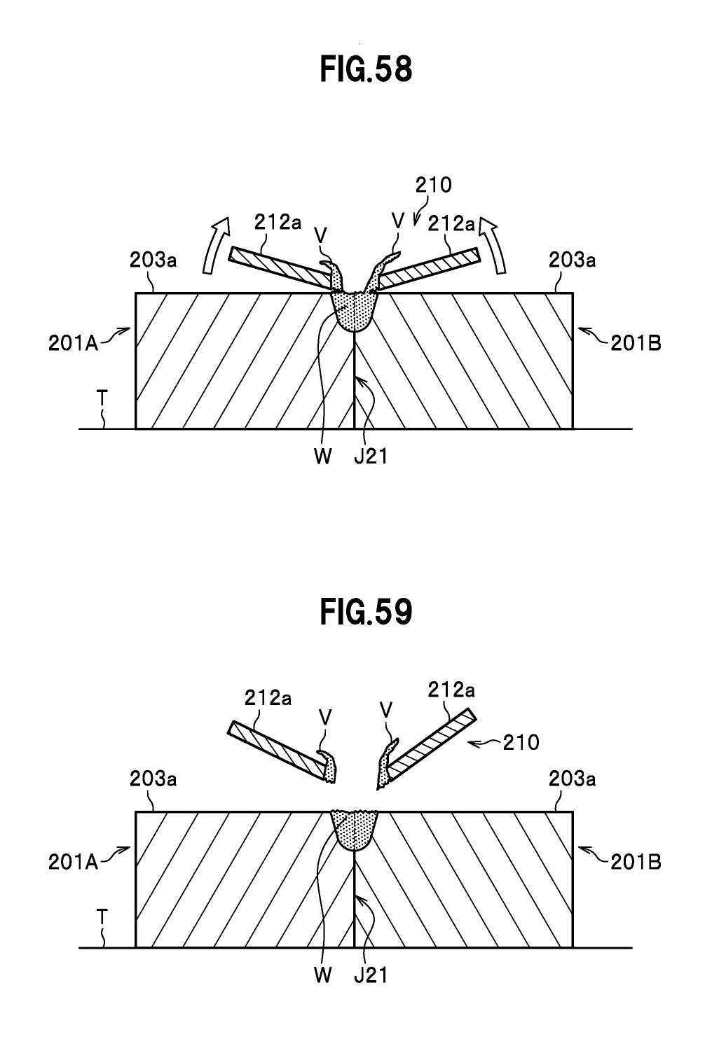

As shown in FIGS. 58 and 59, in the removing step, the auxiliary member 210 is removed from the first metal member 201A and the second metal member 201B. In the removing step, the auxiliary member 210 is folded toward a direction away from the first metal member 201A and the second metal member 201B from both sides manually, for example, to be removed from the first metal member 201A and the second metal member 201B. At this time, the auxiliary member 210 is lifted from the end having one of the slits 125, 125 (see FIG. 54) as a starting point to be folded for removal.

According to the joining method of the present embodiment described above, when the first metal member 201A is joined with the second metal member 201B, the auxiliary member 210 is also joined by frictional stirring. This prevents metal shortage in the joined portion (plasticized region W), to prevent any recessed groove from being formed in the front surface of the butted portion J21 between the first metal member 201A and the second metal member 201B.

Further, since the stirring pin F2 is inserted from the center of the auxiliary member 120 into the butted portion J21, metal shortage in the joined portion is prevented more reliably and a metal is replenished in a well-balanced manner. Still further, since the stirring pin F2 is inserted from the center of the auxiliary member 120, the stirring pin F2 is easily inserted in the auxiliary member 120.

Yet further, according to the present embodiment, the burrs V, V are generated on the respective parts of the auxiliary member 210 that are divided in the frictional stirring step, but are removed together with the whole auxiliary member 210 in the removing step. Thus, the burrs V, V are easily removed. The auxiliary member 210 may be removed with the removing device or the like, but is easily removed manually in the present embodiment.

Here, in the joining method according to the present embodiment, the auxiliary member 210 is set to be significantly thinner than the first metal member 201A and the second metal member 201B. If the shoulder portion of the rotary tool is pressed against the metal members for frictional stirring as in a conventional method, the shoulder portion is brought in contact with the auxiliary member 210, to cause the auxiliary member 210 to be scattered outside, so that metal shortage in the joined portion where the butted portion J21 is joined is not compensated. In contrast, in the present embodiment, since only the stirring pin F2 of the joining rotary tool F is brought in contact with the auxiliary member 210, the first metal member 201A and the second metal member 201B for frictional stirring, the auxiliary member 210 is not scattered outside, so that metal shortage in the joined portion is compensated. Further, in the present embodiment, the overlaid portion J21 at a deeper position under the auxiliary member 210 is joined with a reduced load applied to the frictional stir device as compared with the case where the shoulder portion of the rotary tool is contacted.

### [Modification]

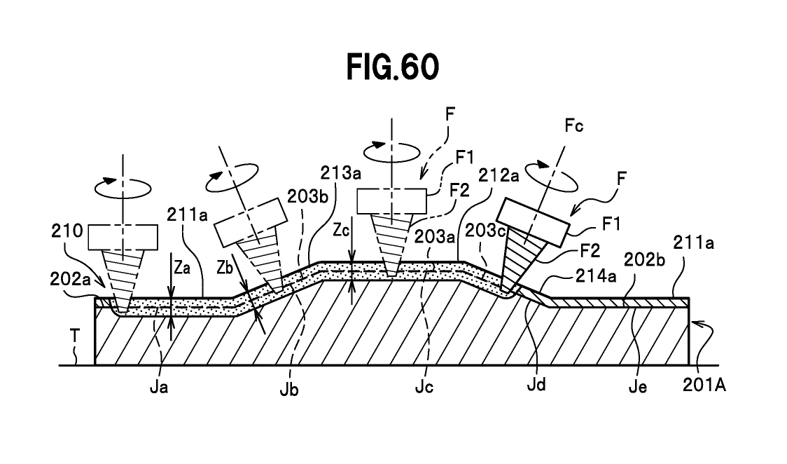

FIG. 60 is a sectional view showing a modified frictional stirring step of the joining method according to the twelfth embodiment. As shown in FIG. 60, in the modification, during the frictional stirring step, the joining rotation tool F is inserted vertically into the butted portion J21 for frictional stirring. In the modified frictional stirring step, the rotation axis Fc of the joining rotary tool F is set to be in parallel with the vertical axis for frictional stirring on the first flat portion Ja, the second flat portion Jc and the third flat portion Je as in the twelfth embodiment. On the other hand, the joining rotary tool F is inclined with respect to the vertical axis on the first inclined portion Jb and the second inclined portion Jd, to make the rotation axis Fc orthogonal to the front surfaces of the first metal member 201A and the second metal member 201B for frictional stirring.

For executing the modification, the joining rotary tool F is preferably attached to a robot arm, for example, having a rotary drive device such as a spindle unit at the distal end. According to such a frictional stir device, the angle of the rotation axis Fc of joining rotary tool F is easily changed. Accordingly, even when the height of the overlaid portion J21 varies, during frictional stirring, the angle of the rotation axis Fc of joining rotary tool F with respect to the vertical axis is changed, to make the joining rotary tool F always orthogonal to the front surfaces of the first metal member 201A and the second metal member 201B for continuous frictional stirring.

Even in the modification described above, substantially the same advantageous effects as the twelfth embodiment are obtained. Further, since the joining rotary tool F is inserted in the front surfaces of the first metal member 201A and the second metal member 201B vertically, even the butted portion J21 having inclined surfaces is frictionally stirred to a deep position.

### Thirteenth Embodiment

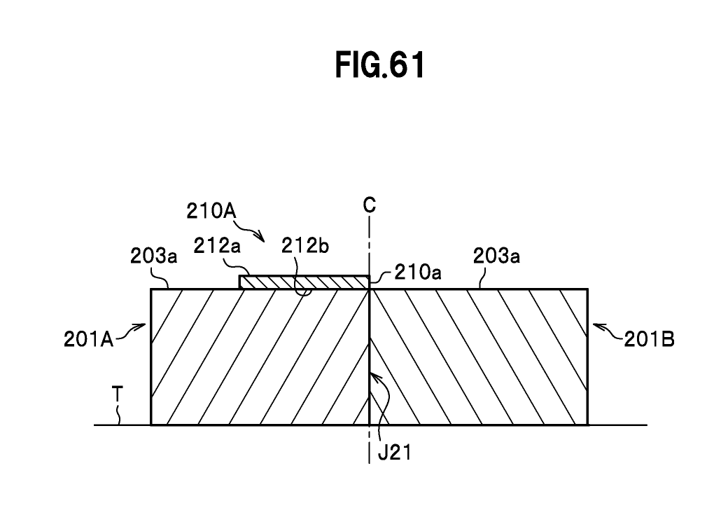

Next, a description will be given of the joining method according to a thirteenth embodiment. The joining method according to the thirteenth embodiment differs from the twelfth embodiment in that the joining rotary tool F is inserted from an end surface 210a of an auxiliary member 210A shown in FIG. 61. Further, the slits 215, 215 are not formed in the auxiliary member 210A. The joining method according to the thirteenth embodiment will be described, focusing on the differences from the twelfth embodiment.

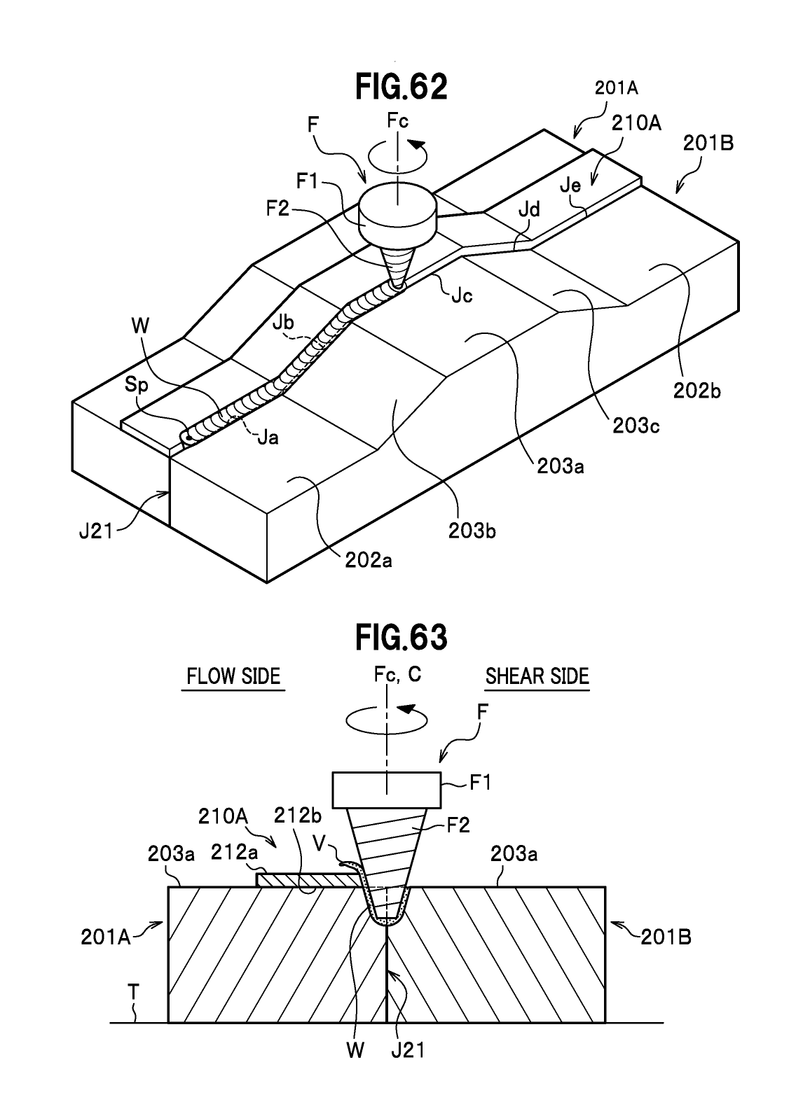

The joining method according to the present embodiment includes the butting step, the arranging step, the frictional stirring step and the removing step. The butting step is the same as that in the twelfth embodiment and the description thereof will be omitted. As shown in FIGS. 61 and 62, in the arranging step, the auxiliary member 210A is arranged on the front surface of the first metal member 201A with its end surface 210a being on the boundary C of the butted portion J21 between the first metal member 201A and the second metal member 201B. The auxiliary member 210A in the thirteenth embodiment has a width about half the width of the auxiliary member 210 in the twelfth embodiment.

As shown in FIGS. 62 and 63, in the frictional stirring step, the butted portion J21 between the first metal member 201A and the second metal member 201B is joined by frictional stirring with the joining rotary tool F. In the present embodiment, since the joining rotary tool F is rotated counterclockwise, the spiral groove of the stirring pin F2 is formed clockwise from the base end toward the distal end. In other words, the spiral groove can be traced from the base end toward the distal end to find that it is formed clockwise as viewed from above.

In the frictional stirring step, only the stirring pin F2 rotated counterclockwise is inserted and relatively moved while the coupling portion F1 is kept away from the joined metal members. In other words, the base end of the stirring pin F2 is kept exposed during frictional stir joining. In the present embodiment, as shown in FIG. 62, the joining rotary tool F is relatively moved in a state that the rotation axis Fc of the joining rotary tool F is in line with the boundary C and the stirring pin F2 is in contact with the first metal member 201A, the second metal member 201B and the auxiliary member 210A.

In the present embodiment, the moving direction and the rotating direction of the joining rotary tool F is set such that the shear side (advancing side: side on which the moving speed of the rotary tool is added to the tangential speed on the circumference of the rotary tool) of the joining rotary tool F is located at the right in the traveling direction. The rotating direction and the traveling direction of the joining rotary tool F are not limited to those described above and may be set appropriately.

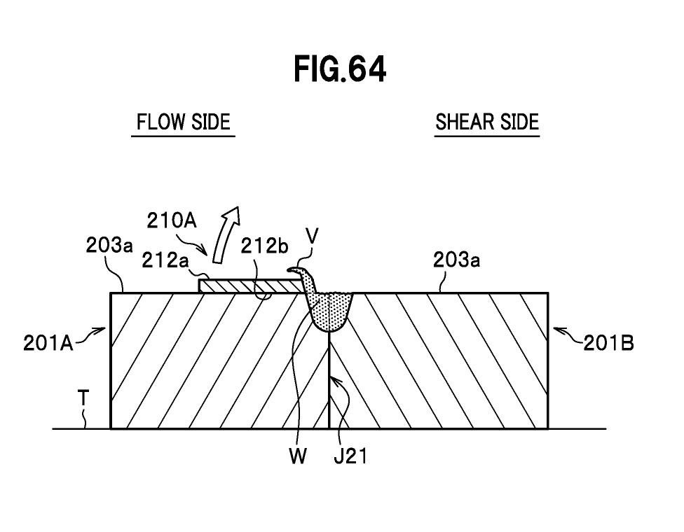

In the present embodiment, since the rotating speed of the joining rotary tool F is set to be fast, the burrs V tend to be generated more on the flow side (Re side) outside the plasticized region W as shown in FIG. 64. Further, setting the rotating speed of the joining rotary tool F to be fast allows the moving (feeding) speed of the joining rotary tool F to be increased. This shortens a joining cycle.

In the frictional stirring step, it depends on the joining condition on which side of the traveling direction of the joining rotary tool F the burrs V are generated. In the frictional stirring step, the joining condition is preferably set such that the burrs V are generated on the auxiliary member 210A. The insertion depth of the stirring pin F2 is set, in the present embodiment, such that the stirring pin F2 contacts (reaches) the first metal member 201A and the second metal member 201B.

As shown in FIG. 64, in the removing step, the auxiliary member 210A is removed from the first metal member 201A. In the removing step, the auxiliary member 210A is folded toward a direction away from the first metal member 201A as shown by the arrow manually, for example, to be removed from the first metal member 201A. Accordingly, the first metal member 201A is joined with the second metal member 201B at the butted portion J21.

According to the joining method of the present embodiments described above, when the first metal member 201A is joined with the second metal member 201B, the auxiliary member 210A is also joined by frictional stirring. This prevents metal shortage in the joined portion (plasticized region W), to prevent any recessed groove from being formed in the front surfaces of the first metal member 201A and the second metal member 201B.

Further, according to the present embodiments, the burrs V are generated on the auxiliary member 210A in the frictional stirring step, but are removed together with the whole auxiliary member 210A in the removing step. Thus, the burrs V are easily removed. The auxiliary member 210A may be removed with the removing device or the like, but is easily removed manually in the present embodiment.

### Fourteenth Embodiment

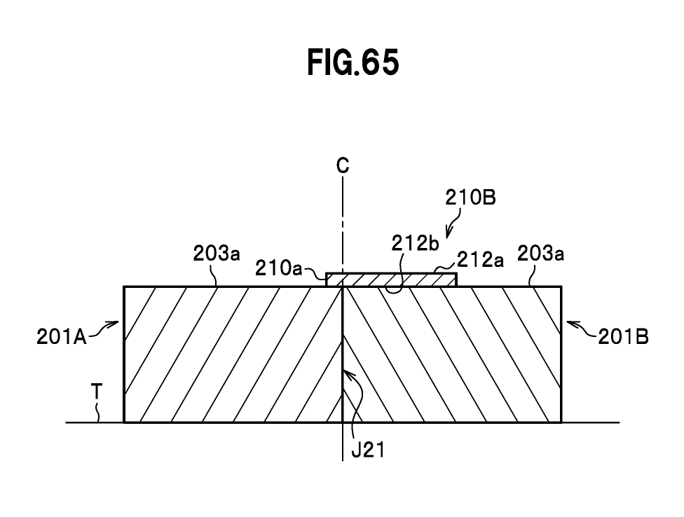

Next, a description will be given of the joining method according to a fourteenth embodiment of the present invention. As shown in FIGS. 65 to 68, in the joining method according to the fourteenth embodiment, the arranged position of the auxiliary member 210B and the insertion position of the stirring pin F2 mainly differ from those in the thirteenth embodiment. The joining method according to the fourteenth embodiment will be described, focusing on the differences from the thirteenth embodiment. The joining method according to the fourteenth embodiment includes the butting step, the arranging step, the frictional stirring step and the removing step.

The butting step is the same as that in the thirteenth embodiment and the description thereof will be omitted. As shown in FIG. 65, in the arranging step, the auxiliary member 210B is mainly arranged on the front surface of the second metal member 201B such that the end surface 210a slightly runs over (protrudes) the boundary C onto the front surface of the first metal member 201A. The distance from the boundary C to the end surface 210a is set such that the joined portion (plasticized region W) is not short of metal after the frictional stirring step to be described later and the auxiliary member 210B is not left on the first metal member 201A after the frictional stirring step.

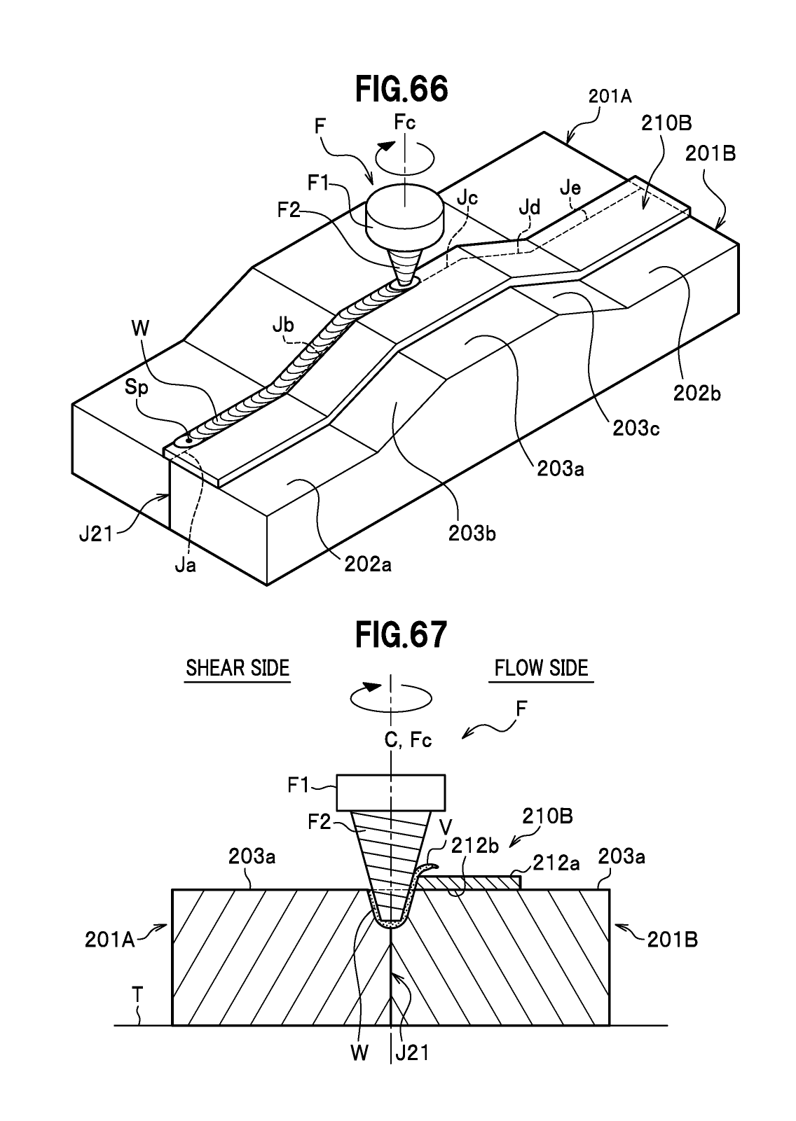

As shown in FIG. 66, in the frictional stirring step, the butted portion J21 between the first metal member 201A and the second metal member 201B is joined by frictional stirring with the joining rotary tool F. In the present embodiment, since the joining rotary tool F is rotated clockwise, the spiral groove of the stirring pin F2 is formed counterclockwise from the base end toward the distal end.

In the frictional stirring step, while the rotation axis Fc of the joining rotary tool F is in line with the boundary C (see FIG. 65), only the stirring pin F2 rotated clockwise is inserted in the butting portion J21, and relatively moved while the coupling portion F1 is kept away from the joined metal members. In the present embodiment, as shown in FIG. 66, the joining rotary tool F is set to travel such that the auxiliary member 210B is positioned at the right in the traveling direction of the joining rotary tool F, and rotated at a high speed. Accordingly, in the present embodiment, as shown in FIG. 67, the burrs V are generated on flow side (Re side) of the auxiliary member 210B.

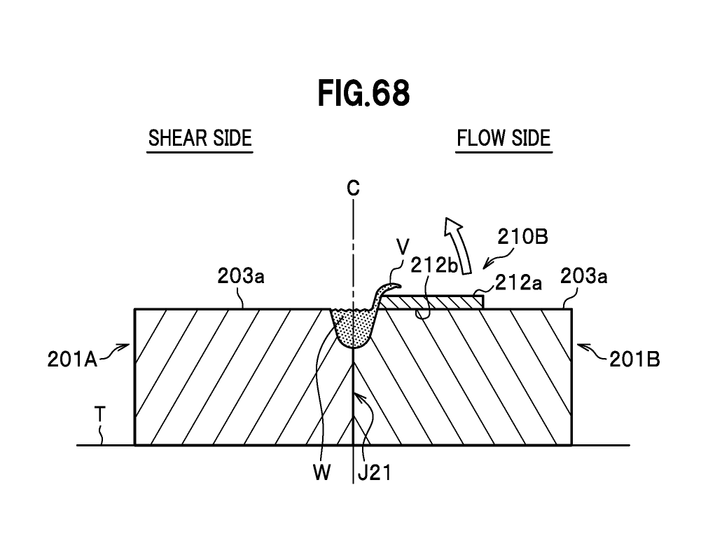

As shown in FIG. 68, in the removing step, the auxiliary member 210B is removed from the second metal member 201B. In the removing step, the auxiliary member 210B is folded toward a direction (arrow direction) away from the second metal member 201B manually, for example, to be removed from the second metal member 201B.

According to the joining method of the present embodiment described above, when the first metal member 201A is joined with the second metal member 201B, the auxiliary member 210B is also joined by frictional stirring. This prevents metal shortage in the joined portion (plasticized region W).

Further, according to the joining condition of the present embodiment, since the rotating speed of the joining rotary tool F is set to be fast, the burrs V are generated more on the flow side outside the plasticized region W. In other words, the rotating direction and the traveling direction of the joining rotary tool F and the like (joining condition) are set such that the burrs V are aggregated on the remaining auxiliary member 210B after the frictional stirring step. Accordingly, the burrs V generated on the auxiliary member 210B are removed together with the whole auxiliary member 210B, to facilitate the burr removing step. Further, the auxiliary member 210B may be removed with the removing device or the like, but is easily removed manually.

Here, in the removing step in the twelfth embodiment described above, parts of the auxiliary member 210 on both sides of the center of the plasticized region W need to be removed. However, in the present embodiment, the auxiliary member 210B is arranged such that the auxiliary member 210B does not remain on the other side of the boundary C (one of the first metal member 201A and the second metal member 201B having a less contact area with the auxiliary member 210B) after the frictional stirring step. Therefore, only the auxiliary member 210B remaining on one side of the boundary C (one of the first metal member 201A and the second metal member 201B having a larger contact area with the auxiliary member 210B) needs to be removed in the removing step. Accordingly, a work in the removing step is reduced.

Further, the auxiliary member 210B is positioned such that the end surface 210a slightly runs over (protrudes) the boundary C onto the first metal member 201 (other side). Therefore, since the protruded portion of the auxiliary member 210B is also stirred frictionally to be replenished to the joined portion (plasticized region W), metal shortage in the joined portion is more reliably prevented in a well-balanced manner. Further, since the rotation axis Fc is slightly shifted toward the center from the end surface 210a of the auxiliary member 210B, the stirring pin F2 is easily inserted in the auxiliary member 210B.

### Alternative Embodiment

Next, a description will be given of alternative embodiment of the present invention. The joining method according to the alternative embodiment includes the butting step, the arranging step, the frictional stirring step and the removing step. This embodiment differs from the twelfth to fourteenth embodiments in that the metal members are curved upward and downward.

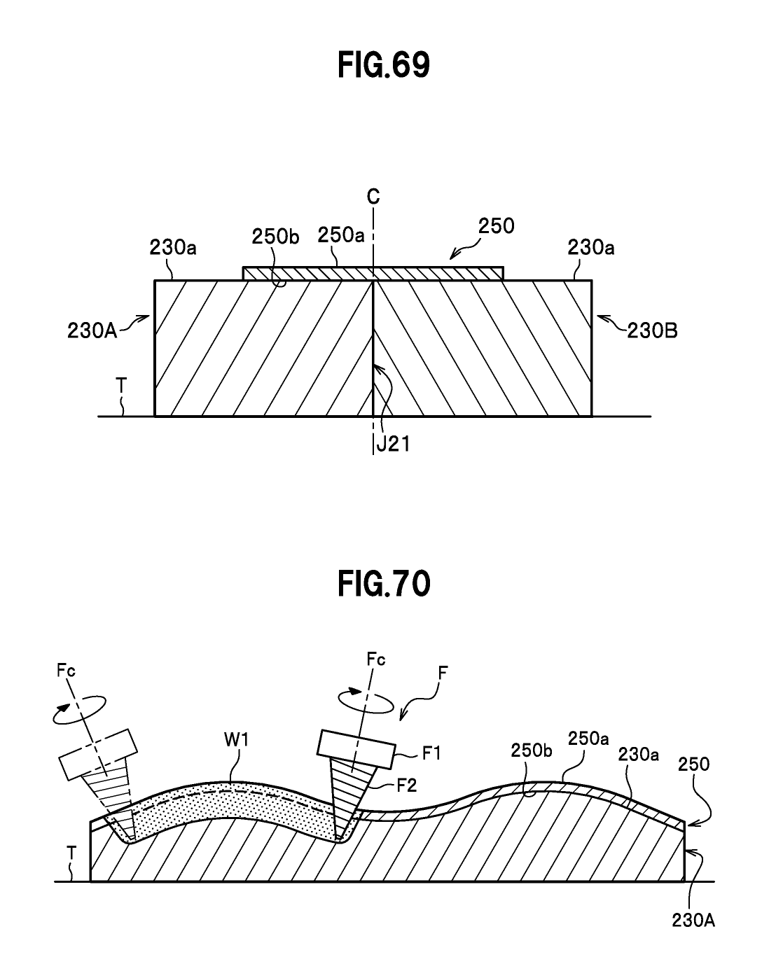

As shown in FIGS. 69 and 70, in the butting step, a first metal member 230A and a second metal member 230B the upper surfaces of which are curved are pressed against each other. The butted portion J21 is formed in the butting step. The first metal member 230A and the second metal member 230B are formed of a frictionally stirrable metal, and are formed in a curve having the same radius of curvature such that front surfaces 230a, 230a are flush with each other.

In the arranging step, a rear surface 250b of a plate-shaped auxiliary member 250 curved in the same shape as the first metal member 230A and the second metal member 230B is brought in contact with the center between the front surfaces of the first metal member 230A and the second metal member 230B in a butted state. Note that the first metal member 230A, the second metal member 230B and the auxiliary member 250 are immovably fixed to the frame T with the jig (not shown).

In the frictional stirring step, the butted portion J21 is frictionally stirred with the joining rotary tool F. In the frictional stirring step, the stirring pin F2 of the joining rotary tool F is inserted from a front surface 250a of the auxiliary member 250 into the butted portion J21 between the first metal member 230A and the second metal member 230B, and relatively moved in the butted portion J21. In the frictional stirring step, the inclination angle of the joining rotary tool F is gradually changed such that the rotation axis Fc of joining rotary tool F is in line with each of the normal lines of the auxiliary member 250, the first metal member 230A and the second metal member 230B. Further, in the frictional stirring step, the insertion depth of the stirring pin F2 is set to have a constant depth of the plasticized region W1. The removing step is the same as that in the twelfth embodiment and the description thereof will be omitted.

As the joining method according to alternative embodiment described above, even if the butted portion J21 is curved in the vertical direction to have a varying height, substantially the same advantageous effects are obtained as the twelfth to fourteenth embodiments.

The embodiments of the present invention have been described above, but may be modified within the scope not departing from the spirit of the present invention. For example, the present embodiments include the removing step, but the auxiliary member may be left as is, without being removed, on the first metal member and the second metal member.

### EXPLANATION OF REFERENCES

1 first metal member

2 second metal member

10 auxiliary member

F joining rotary tool (rotary tool)

F1 coupling portion

F2 stirring pin

J1 butted portion

V burr

W plasticized region

C boundary

Z reference line

1. A joining method for joining a first metal member with a second metal member with use of a rotary tool having a stirring pin, comprising steps of:
butting the first metal member with the second metal member to form a butted portion;
arranging an auxiliary member to be in surface-contact with the first metal member or the second metal member; and
frictional stirring the butted portion in which the rotating stirring pin is inserted from a front surface of the auxiliary member and the rotary tool is relatively moved in the butted portion to join the first metal member, the second metal member and the auxiliary member, in the state that only the stirring pin is brought in contact with the first metal member, the second metal member and the auxiliary member.

2. The joining method according to claim 1, further comprising a step of:
removing the auxiliary member having a burr from the first metal member or the second metal member.

3. The joining method according to claim 2, wherein, in the frictional stirring step, a joining condition is set such that the burr to be generated in frictional stir joining is generated on the auxiliary member.

4. A joining method for joining a first metal member with a second metal member with use of a rotary tool having a stirring pin, comprising steps of:
butting the first metal member with the second metal member to form a butted portion;
arranging an auxiliary member to be in surface-contact with the first metal member and the second metal member; and
frictional stirring the butted portion in which the rotating stirring pin is inserted from a front surface of the auxiliary member and the rotary tool is relatively moved in the butted portion to join the first metal member, the second metal member and the auxiliary member, in the state that only the stirring pin is brought in contact with the first metal member, the second metal member and the auxiliary member.

5. The joining method according to claim 4, further comprising a step of:
removing the auxiliary member having a burr from the first metal member and the second metal member.

6. The joining method according to claim 5,
wherein, in the arranging step, the auxiliary member is arranged on one of the first metal member and the second metal member so as to slightly run over the butted portion onto the other such that the auxiliary member is not left on the other side after the frictional stirring step, and
wherein, in the frictional stirring step, a joining condition is set such that the burr to be generated in frictional stir joining is generated on the auxiliary member on said one of the first metal member and the second metal member.

7. A joining method for joining a first metal member with a second metal member with use of a rotary tool having a stirring pin, comprising steps of:
butting the first metal member with the second metal member to form a butted portion;
arranging an auxiliary member to be in surface-contact with the first metal member or the second metal member; and
frictional stirring the butted portion in which the rotating stirring pin is inserted from a front surface of the auxiliary member and the rotary tool is relatively moved in the butted portion to join the first metal member, the second metal member and the auxiliary member, in the state that only the stirring pin is brought in contact with the first metal member, the second metal member and the auxiliary member,
wherein, in the butting step, a gap is defined in the butted portion when the butted portion is formed.

8. The joining method according to claim 7, further comprising a step of:
removing the auxiliary member having a burr from the first metal member or the second metal member.

9. The joining method according to claim 8, wherein, in the frictional stirring step, a joining condition is set such that the burr to be generated in frictional stir joining is generated on the auxiliary member.

10. A joining method for joining a first metal member with a second metal member with use of a rotary tool having a stirring pin, comprising steps of:
butting the first metal member with the second metal member to form a butted portion;
arranging an auxiliary member to be in surface-contact with the first metal member and the second metal member; and
frictional stirring the butted portion in which the rotating stirring pin is inserted from a front surface of the auxiliary member and the rotary tool is relatively moved in the butted portion to join the first metal member, the second metal member and the auxiliary member, in the state that only the stirring pin is brought in contact with the first metal member, the second metal member and the auxiliary member,
wherein, in the butting step, a gap is defined in the butted portion when the butted portion is formed.

11. The joining method according to claim 10, further comprising a step of:
removing the auxiliary member having a burr from the first metal member and the second metal member.

12. The joining method according to claim 11,
wherein, in the arranging step, the auxiliary member is arranged on one of the first metal member and the second metal member so as to slightly run over the butted portion onto the other, and
wherein, in the frictional stirring step, a joining condition is set such that the burr to be generated in frictional stir joining is generated on the auxiliary member on said one of the first metal member and the second metal member.

13-38. (canceled)
